(19) United States
(12) Patent Application Publication
(10) Pub. No.: US 2010/0048274 A1
(43) Pub. Date: Feb. 25, 2010

(54) GAME TERMINAL, SERVER DEVICE THEREFOR, COMPUTER PROGRAM THEREFOR, AND COMPUTER-READABLE RECORDING MEDIUM THEREWITH

(75) Inventors: Shuichi Kura, Tokyo (JP); Yohei Marufuji, Tokyo (JP)

Correspondence Address: WINSTON & STRAWN LLP;PATENT DEPARTMENT, 1700 K STREET, N.W., WASHINGTON, DC, 20006, US

(73) Assignee: Konami Digital Entertainment Co., Ltd.

(21) Appl. No.: 12/523,449

(22) PCT Filed: Jan. 17, 2008
(86) PCT No.: PCT/JP2008/050496

§ 371 Date: Sep. 9, 2009

(30) Foreign Application Priority Data
Jan. 22, 2007 (JP) 2007-011165
Sep. 19, 2007 (JP) 2007-010246

(51) Int. Cl. A63F 9/24; A63F 13/00

(52) U.S. Cl. 463/9; 463/30; 463/43

(57) ABSTRACT

The present invention provides a game system (1) having plural game terminals (10) and a server device (40). In each game terminal (10), processor (150) asks a quiz question, receives an answer, and generates quiz result data indicating a quiz question ID of the quiz question and whether the answer to the question was correct, for transmission to the server device (40). Server device (40) has stored therein, for each quiz question, calculation mandatory data. Processor (410) of the server device receives quiz result data from each game terminal (10) to update the calculation mandatory data, calculates an accuracy rate using the latest calculation mandatory data, and transmits to each game terminal (10) a do-not-ask list indicating a quiz question ID of a quiz question for which the accuracy rate is outside an adequate range determined in advance.

### TECHNICAL FIELD

The present invention relates to a game system for enabling a player to play a quiz game including a quiz, a server device therefor, a computer program therefor, and also relates to a computer-readable recording medium therewith.

### BACKGROUND ART

There is disclosed in Japanese Patent Application Laid-Open Publication No. 2006-055294 a game system enabling a player to play a quiz game by executing a series of processes for asking quiz questions to a player and receiving an answer to a quiz question from the player. In this game system, a quiz question is selected from a genre selected by a player, and the selected quiz question is asked in a quiz.

A game system enabling a player to play a quiz game must have stored therein, for each quiz question, quiz question data indicating a quiz question to be asked and correct answer data indicating a correct answer of the quiz question. Storage of quiz question data and correct answer data requires an operation of devising a quiz question and a correct answer therefor and an operation of generating quiz question data and correct answer data based on the devised quiz question and the correct answer. However, a human error (for example, incorrect input) cannot be totally avoided in such operations. As a result, a quiz could possibly be erroneous.

An erroneous quiz is a quiz in which an answer based on correct knowledge is designated as an incorrect answer. A quiz is erroneous, for example when a correct answer indicated by correct answer data corresponding to quiz question data is not a correct answer to a quiz question represented by the quiz question data. One such example would be a quiz question represented by quiz question data being “The three primary colors of light are red, blue, and what?” and a correct answer indicated by correct answer data corresponding to the quiz question data is “red”.

Repeatedly asking a quiz question for an erroneous quiz (hereinafter referred to as an “inadequate question to be asked”) could lead to lowering of motivation of a player who wishes to play a quiz game. Therefore, an inadequate question to be asked should be detected. However, in a conventional game system as typified by the game system described in Japanese Patent Application Laid-Open Publication No. 2006-055294, no detection of an inadequate question to be asked is performed. Therefore, a human will have to detect an inadequate question to be asked by comparing quiz question data to correct answer data. However, there still could be problems overlooked.

### DISCLOSURE OF INVENTION

The present invention has been achieved in view of the above-stated circumstances and, it has as an object to provide a game system capable of reliably detecting an inadequate question to be asked, a server device therefor, a computer program therefor, and also to provide a computer-readable recording medium therewith.

In the following, description will be given of the present invention. It should be noted that reference numerals in the attached drawings are shown in parentheses to facilitate understanding of the present invention; however, this is not intended to limit the present invention to the embodiments as shown in the drawings.

The present invention provides a game system (1) for enabling a player to play a quiz game including a quiz, the game system having: plural game terminals (10); and a server device (40), with each of the plural game terminals (10) having: a question blocking data receiver (150, SD1) that receives, from the server device (40), question blocking data for blocking a particular quiz question from being asked; a quiz question decider (150, SD2) that decides a quiz question to be asked in the quiz based on the question blocking data received by the question blocking data receiver (150, SD1); a questioner (150, SD6) that, in the quiz, asks the player the quiz question decided by the quiz question decider (150, SD2); an answer receiver (150, SD6) that, in the quiz, receives an answer to the quiz question asked by the questioner (150, SD6); an answer determiner (150, SD10) that determines whether the answer received by the answer receiver (150, SD6) is correct; and a quiz result data transmitter (150, SD18) that generates quiz result data indicating an identifier of a quiz question for which an answer is received by the answer receiver (150, SD6) and also indicating whether the answer received was found to be correct and that transmits the generated quiz result data to the server device (40), and with the server device (40) having: a quiz result data receiver (410, 420) for receiving quiz result data from each of the plural game terminals (10); a calculation mandatory data storage device (430) that stores, for each quiz question, data of parameters mandatory for accuracy rate calculation as calculation mandatory data; a calculation mandatory data updater (410, SA31) that updates, based on the quiz result data received by the quiz result data receiver (410, 420), the calculation mandatory data for a quiz question having an identifier indicated by the quiz result data; an accuracy rate calculator (410, SA32) that calculates, with the calculation mandatory data updated by the calculation mandatory data updater (410, SA31), the accuracy rate of a quiz question corresponding to the calculation mandatory data; an accuracy rate adequacy determiner (410, SA4) that determines whether the accuracy rate calculated by the accuracy rate calculator (410, SA32) is outside a predetermined adequate range; and a question blocking data transmitter (410, 420) that transmits, to each of the plural game terminals (10), the question blocking data in which a quiz question having the accuracy rate that is determined by the accuracy rate adequacy determiner (410, SA4) to be outside the adequate range is set as the particular quiz question.

According to this game system (1), asking a quiz question for which the latest accuracy rate is outside the adequate range can be blocked. An inadequate quiz question to be asked is a quiz question for an erroneous quiz. Because an answer based on correct knowledge will be a wrong answer in the erroneous quiz, the accuracy rate of an inadequate quiz question to be asked will be extremely low. According to the game system (1), an inadequate question to be asked can be reliably detected and the asking of the detected quiz question can be blocked by appropriately setting an adequate range.

A method for blocking asking a quiz question can be freely selected. For example, in a case in which quiz question data representing a quiz question is stored in advance in each of the plural game terminals (10), data instructing deletion of quiz question data of a quiz question for which the accuracy rate is outside the adequate range may be used as the question blocking data, so that each of game terminals (10) may delete the quiz question data in accordance with the question blocking data from server device (40). Furthermore, for example, in a case in which quiz question data of a quiz question which game terminal (10) is caused to ask is transmitted from server device (40) to game terminal (10) for each quiz question, it may be configured so that server device (40) does not transmit quiz question data of a quiz question for which the accuracy rate does not fall within the adequate range. Furthermore, the adequate range can be determined for each quiz question or may be determined as having the same range for all the questions. Still furthermore, the number of questions asked in one quiz game may be one or plural.

In the above game system (1), the server device (40) may further have a difficulty degree (difficulty level) data storage device (430) that stores, for each quiz question, difficulty degree data showing the degree of difficulty for each quiz question; the adequate range may be determined in advance depending on the degree of difficulty for a quiz question; and the accuracy rate adequacy determiner (410, SA4) may determine whether the accuracy rate calculated by the accuracy rate calculator (410, SA32) is outside the adequate range determined in advance depending on the degree of difficulty of the quiz question for which the accuracy rate was calculated by the accuracy rate calculator (410, SA32).

According to this embodiment, because the adequate range is determined depending on the difficulty degree of a quiz question, more reliable and speedy detection of an inadequate question to be asked can be performed.

Furthermore, in the above game system (1), the question blocking data may indicate an identifier of the particular quiz question; and the quiz question decider (150, SD2) may decide, as a quiz question to be asked in the quiz, a quiz question having an identifier that is not indicated by the question blocking data received by the question blocking data receiver (150, SD1).

According to this embodiment, in a case in which quiz question data indicating a quiz question is stored in advance in each of plural game terminals (10), the asking of an inadequate question to be asked can be blocked without requiring time-consuming operations such as deleting, adding, and updating quiz question data at each game terminal (10). Furthermore, because the data size of an identifier for a quiz question is usually smaller than the size of quiz question data, the amount of communication between server device (40) and each game terminal (10) can be reduced according to this embodiment.

In another aspect, the present invention provides a server device (40) for providing a service to each of plural game terminals (10), the server device (40) having: a quiz result data receiver (410, 420) for receiving quiz result data from each of the plural game terminals (10) that receives question blocking data for blocking a particular quiz question from being asked in a quiz, that decides a quiz question to be asked in the quiz, that asks a player the decided the quiz question in the quiz, that receives an answer to the quiz question in the quiz, and that generates quiz result data showing an identifier of the quiz question and a result of the quiz for transmission; a calculation mandatory data storage device (430) that stores, for each quiz question, data of parameters mandatory for accuracy rate calculation as calculation mandatory data; a calculation mandatory data updater (410, SA31) that, based on quiz result data received by the quiz result data receiver (410, 420), updates the calculation mandatory data for a quiz question having an identifier indicated by the quiz result data; an accuracy rate calculator (410, SA32) that uses the calculation mandatory data updated by the calculation mandatory data updater (410, SA31) and that calculates the accuracy rate of a quiz question corresponding to the calculation mandatory data; an accuracy rate adequacy determiner (410, SA4) that determines whether the accuracy rate calculated by the accuracy rate calculator (410, SA32) is outside a predetermined adequate range; and a question blocking data transmitter (410, 420) that transmits, to each of the plural game terminals (10), the question blocking data in which a quiz question having the accuracy rate that is determined by the accuracy rate adequacy determiner (410, SA4) to be outside the adequate range is set as the particular quiz question.

A game system that uses this server device (40) has the same effects as the above game system (1).

Furthermore, the present invention provides a computer program (P2) or a computer program product for running on a computer (40) that provides a service to each of plural game terminals (10), the computer program, when run on the computer (the computer processor (410)), at least including computer readable instructions for performing the steps of: receiving quiz result data from each of the plural game terminals (10) that receives question blocking data for blocking a particular quiz question from being asked in a quiz, that decides a quiz question to be asked in the quiz, that asks a player the decided quiz question in the quiz, that receives an answer to the quiz question in the quiz, that generates quiz result data indicating an identifier of the quiz question and a result of the quiz for transmission; updating (SA31), based on quiz result data received in the receiving step, calculation mandatory data for a quiz question having an identifier designated by the quiz result data, the calculation mandatory data being stored in a calculation mandatory data storage device that stores, for each quiz question, data of parameters mandatory for accuracy rate calculation as calculation mandatory data; calculating (SA32), by using the calculation mandatory data updated in the updating step (SA31), the accuracy rate of a quiz question corresponding to the calculation mandatory data; determining (SA4) whether the accuracy rate calculated in the calculating step (SA32) is outside a predetermined adequate range; and transmitting (420), to each of the plural game terminals (10), the question blocking data in which a quiz question having the accuracy rate that is determined in the determining step (SA4) to be outside the adequate range is set as the particular quiz question. Preferably, the computer program (P2) or the computer program product (P2) may be downloaded via a communication interface (420) to the computer (40) by connecting to a network (2).

Furthermore, the present invention can be understood as a computer-readable recording medium that has recorded thereon the computer program (P2) or the computer program product (P2). Specifically, the present invention can be understood as that which is recorded, as data loadable onto a memory of a computer, on a floppy (registered trademark) disk, a CD-ROM, or other types of computer-readable recording medium, for distribution.

The same effects as the server device (40) can be attained by a computer that executes this computer program.

### Effects of the Invention

According to the present invention, it is possible to provide a game system in which an inadequate question to be asked can be reliably detected and in which a situation can be avoided of an inadequate question being repeatedly asked, a server device therefor, and a computer program therewith.

### BRIEF DESCRIPTION OF THE DRAWINGS

FIG. 1 is a diagram illustrating a configuration of a game system 1 according to an embodiment of the present invention.

FIG. 2 is a diagram illustrating an external view of a game terminal 10 included in game system 1.

FIG. 3 is a block diagram illustrating a configuration of game terminal 10.

FIG. 4 is a diagram schematically illustrating a configuration of a quiz data set used at game terminal 10.

FIG. 5 is a block diagram illustrating a configuration of a server device 40 included in game system 1.

FIG. 6A is a sequence chart illustrating a part (the first half) of an overview of an operation performed in game system 1.

FIG. 6B is a sequence chart illustrating a part (the second half) of the overview of the operation performed in game system 1.

FIG. 7 is a flowchart illustrating an update process performed at server device 40.

FIG. 8 is a flowchart illustrating a single game process performed at game terminal 10.

FIG. 9 is a flowchart illustrating an association-based selection process included in the single game process.

FIG. 10 is a diagram illustrating an example of an image displayed at a screen 121 of game terminal 10.

FIG. 11 is a flowchart illustrating a part (the first half) of a parent online game process performed at game terminal 10.

FIG. 12 is a flowchart illustrating a part (the second half) of the parent online game process performed at game terminal 10.

FIG. 13 is a diagram illustrating an example of an image displayed at screen 121.

FIG. 14 is a flowchart illustrating an answer collection process included in the parent online game process.

FIG. 15 is a diagram illustrating an example of an image displayed at screen 121.

FIG. 16 is a flowchart illustrating a part (the first half) of a child online game process performed at game terminal 10.

FIG. 17 is a flowchart illustrating a part (the second half) of the child online game process performed at game terminal 10.

FIG. 18 is a schematic diagram for describing a modification 1 of the present embodiment.

FIG. 19 is a schematic diagram for describing the modification 1.

FIG. 20 is a diagram illustrating a partial flowchart of a parent online game process performed at a parent terminal in the modification 1.

FIG. 21 is a diagram illustrating a partial flowchart of a child online game process performed at a child terminal in the modification 1.

### BEST MODE FOR CARRYING OUT THE INVENTION

In the following, description will be given of a preferred embodiment of the present invention with reference to the drawings. The specific configurations described below are merely examples, and the present invention encompasses various embodiments obtained by modifying the specific configurations within its scope.

### 1. Configuration

### 1-1. Game System

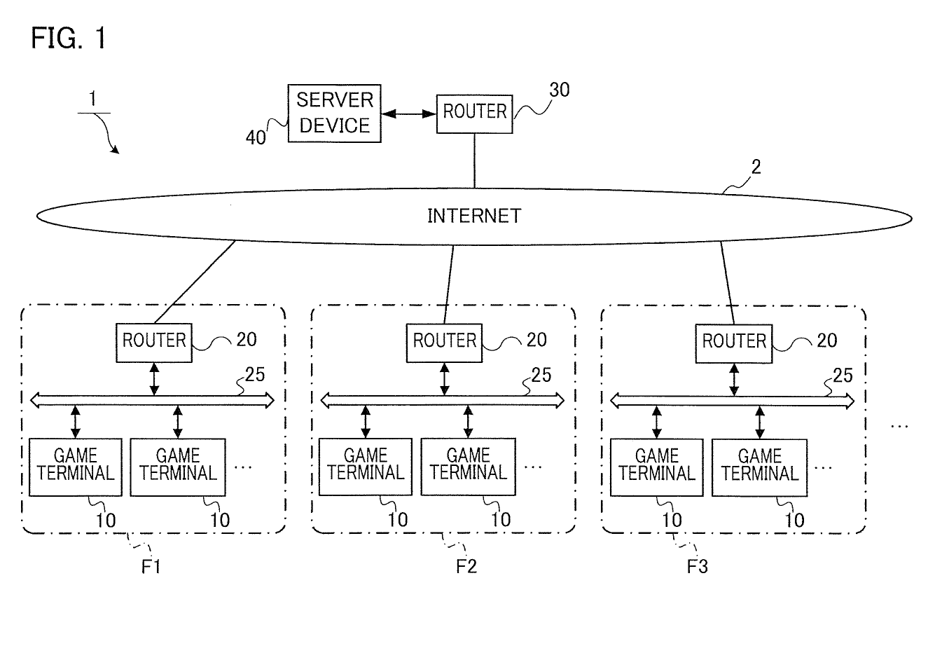

FIG. 1 is a block diagram illustrating a configuration of a game system 1 according to an embodiment of the present invention. Game system 1 is a system in which a player can play a quiz game including plural quiz questions. A quiz is a series of actions of a question master (game system 1 (specifically, a game terminal 10, described later)) giving out a quiz question and an answerer (player) answering the question. In a quiz game, plural quizzes advance sequentially one by one. However, the embodiment may be modified such that plural quizzes advance in parallel in a quiz game.

A player can play a desired one of two types of quiz games using game system 1. One type of the quiz game is a stand-alone game in which the number of participants is one. The other type of the quiz game is a multiple-player participation type online game (multiple-player online game) in which the number of participants is more than one (specifically, 12). The present embodiment may be modified such that the number of participants of the multiple player game is equal to or greater than 13 or equal to or less than 11.

A part of game system 1 is provided at game facilities F (F1, F2, F3, . . . ) such as a venue at which a player who visits the venue can play a game. Specifically, there are provided at each game facility F, a LAN (Local Area Network) 25, one or plural game terminals (computer) 10 connected to LAN 25, enabling a player to play a quiz game, and a router 20 that connects LAN 25 with the Internet 2.

Game terminal 10 is used by a player and is a terminal device (arcade game device) by use of which a player can play a quiz game. The game terminal performs a game process including a quiz process of giving a player a quiz question and receiving an answer to the quiz question from the player. The game process is a process for causing a player to play a quiz game.

Router 20 has a function of building, on the Internet 2, a VPN (Virtual Private Network) which is a virtual dedicated network. Game terminal 10 is capable of communicating, via LAN 25, with another game terminal 10 in game facility F where this game terminal 10 is located, and is also capable of communicating, via LAN 25, router 20, and the Internet 2, with game terminal 10 at another game facility F.

Game system 1 has a server device (computer) 40 that provides various services (processes) (described below) to every game terminal 10 and a router 30 that connects server device 40 to the Internet 2. Server device 40 is capable of communicating with each game terminal 10 via router 30 and the Internet 2. In other words, server device 40 and all the game terminals 10 can communicate with one another. Server device 40 is a single unit, but the present embodiment may be modified such that server device 40 is formed of plural units.

### 1-2. Game Terminal

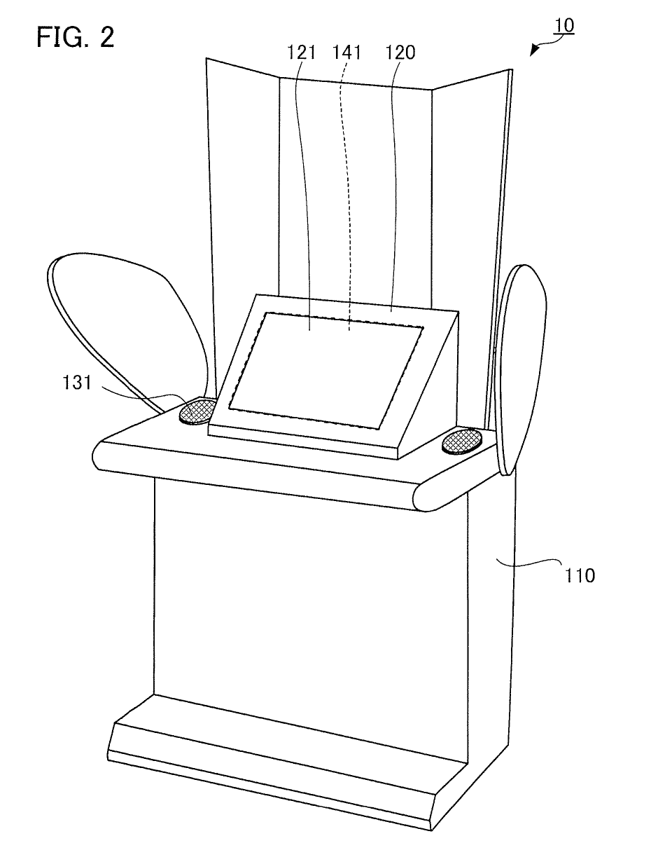

FIG. 2 is a diagram illustrating an external view of game terminal 10 included in game system 1. A player of game terminal 10, in front of a body 110 of game terminal 10, can see an image displayed on a screen 121 of a display unit (specifically, a monitor) 120 provided on body 110 and can also hear sounds emitted from a speaker 131 provided on body 110, and can touch a transparent touch panel 141 provided on body 110 and covering screen 121.

In a quiz, a player is expected to understand a quiz question given by game terminal 10 based on an image displayed on screen 121 and on sounds emitted from speaker 131 and to answer the quiz question by touching touch panel 141.

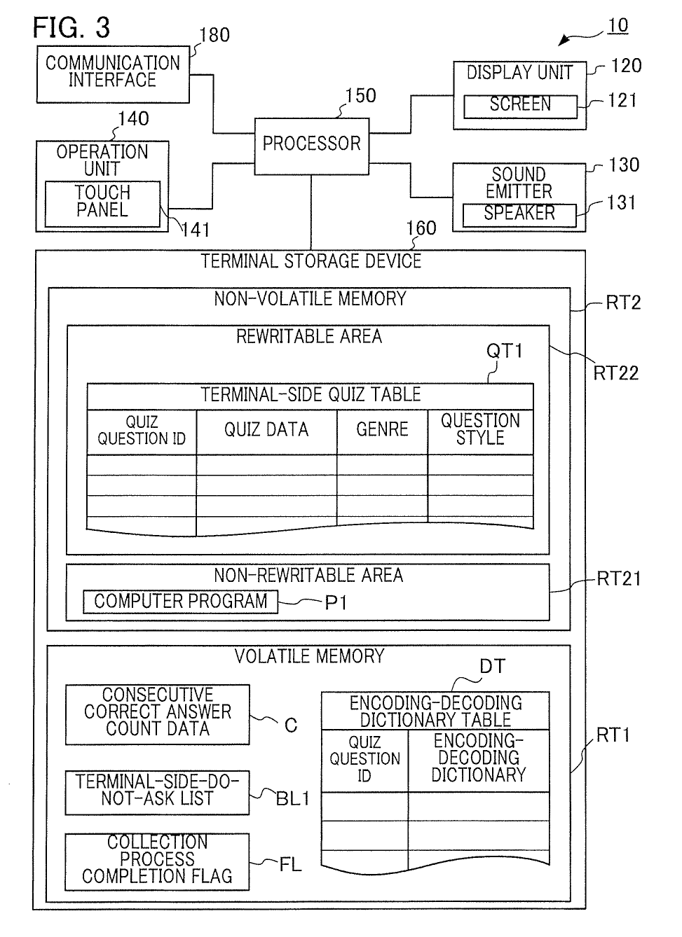

FIG. 3 is a block diagram illustrating a configuration of game terminal 10. As shown in the figure, game terminal 10 has a processor 150 that performs various processes, described later, an operation unit 140 that is operated by a player and that supplies processor 150 with operation data corresponding to the operation of the player, a display unit 120 that displays an image on screen 121 by using image data supplied from processor 150, a sound emitter 130 that emits sounds from speaker 131 by using sound data supplied from processor 150, a terminal storage device 160 that stores various types of data, and a communication interface 180.

Operation unit 140 is provided with touch panel 141. Touch panel 141 supplies processor 150 with operation data corresponding to a position touched by a player. Processor 150 is, for example, one or plural CPUs (Central Processing Units) and performs a game process described below. Communication interface 180 is for transmitting a signal to, and receiving a signal from, LAN 25, and relays data between processor 150 and LAN 25. Processor 150 uses communication interface 180 to transmit data to, and to receive data from, another device. The present embodiment may be modified so as to use a video projector as display unit 120. In this case, a screen on which an image is projected will be screen 121, and operation unit 140 will be provided with a keyboard or buttons, etc.

A memory area of terminal storage device 160 is divided into a volatile area RT1 for which power is required for retaining the memory content and a non-volatile area RT2 for which power is not required. Non-volatile area RT2 is further divided into a non-rewritable area RT21 in which the memory content is non-rewritable, and a rewritable area RT22 in which the memory content is rewritable. Volatile area RT1 can be made, for example, by a RAM (Random Access Memory), non-rewritable area RT21, for example, by a ROM (Read Only Memory), a rewritable area RT22, for example, by a hard disk.

Reserved in rewritable area RT22 is a terminal quiz table QT1. In terminal quiz table QT1, there are stored, for each quiz question, quiz question ID data indicating a quiz question ID (identifier) for uniquely identifying a quiz question, a quiz data set for performing a quiz using a quiz question, genre data representing a genre of the quiz question, question style data representing a question style of the quiz question. Quiz question IDs, genres and question styles are the same in game system 1. That is, it is ensured that a quiz question having the same quiz question ID is the same quiz question, that the genre of the same quiz question is the same, and that the question style of the same quiz question is the same, among devices in game system 1.

A genre (or a category) is a field of knowledge from which a question is given to a player and is, for example, a field of sports or a field of learning, etc. A question style is, for example, a multiple choice question for answering a quiz question by selecting one of plural answer options, a type-in type of question for answering a quiz question by entering characters, etc. The genre and the question style of each quiz question are fixed. The present embodiment may be modified such that plural genres or plural question styles are associated with one quiz question.

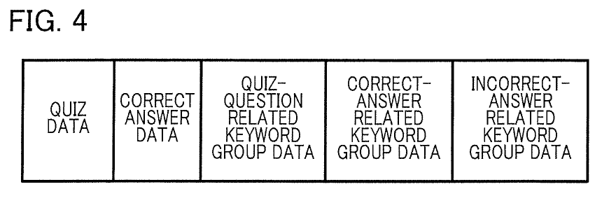

FIG. 4 is a schematic diagram illustrating a configuration of a quiz data set used in game terminal 10. The quiz data set includes quiz question data representing a quiz question, correct answer data representing a correct answer of the quiz question, and keyword group data representing a keyword group including plural keywords (character strings) that are related to a quiz element. In a case in which the question style is of the multiple-choice type, a quiz question includes plural answer options, and the quiz question data includes data representing plural answer options. Only one of these plural answer options is the correct answer.

A quiz element is an element essential to a quiz question and specifically is a quiz question or a correct answer. In a case in which the question style is a multiple-choice question, incorrect answers will also be a quiz element. There are plural types of keyword groups: namely, a quiz-question related keyword group including keywords that are related to a quiz question, a correct-answer related keyword group including keywords that are related to a correct answer, and an incorrect-answer related keyword group including keywords that are related to incorrect answers. Thus, different types of keyword groups include keywords related to quiz elements that differ from group to group. The incorrect-answer related keyword group is provided only in a case in which the question style is of the multiple-choice type.

A quiz data set includes quiz-question related keyword group data representing a quiz-question related keyword group and correct-answer related keyword group data representing a correct-answer related keyword group. A quiz data set of a quiz question for which the question style is of the multiple choice type further includes incorrect-answer related keyword group data representing an incorrect-answer related keyword group. Furthermore, each keyword group data includes data representing one common keyword. That is, each keyword group data includes at least one keyword that is in common to all quiz data sets and also to all keyword groups.

Stored in the volatile area RT1 are a terminal-side-do-not-ask list BL1 (question blocking data) for prohibiting asking of inadequate questions to be asked and consecutive correct answer count data C representing the number of consecutive correct answers. The inadequate questions to be asked include a quiz question that is inadequate for asking such as a quiz question for which a correct answer cannot be given. A terminal-side-do-not-ask list BL1 is a list containing pieces of quiz question ID data of inadequate questions to be asked and is delivered from server device 40. As described below, plural quiz questions are asked sequentially one by one in a quiz game. The number of consecutive correct answers is initially set to 0, and it increments by one every time a correct answer is given to a quiz question and is reset to 0 when an incorrect answer is given. In volatile area RT1, a collection process completion flag FL (described below) and an encoding-decoding dictionary table DT (described below) can be retained.

Stored in the non-rewritable area RT21 is a computer program P1. Computer program P1 includes computer-readable instructions, and when computer program P1 is run and executed by processor 150, computer program P1 causes game terminal 10 to perform a game process. The game process includes a terminal-side grouping process for forming a group with another game terminal 10, a single game process for causing a player to play a stand-alone type game, and an online game process for causing a player to play a multiple player online game.

A group is a collection of game terminals 10, and one multiple-player online game advances by the same game terminals 10 in the same group communicating with one another. The number of groups to which one game terminal 10 belongs is one. In each group, from among game terminals 10 belonging to each group, one terminal is a parent (master) game terminal 10 (parent terminal) capable of directly transmitting data to, and receiving data from, every other game terminal 10, and each of the other terminals is a child (client) game terminal 10 (child terminal) capable of directly transmitting data only to, and receiving data only from, the parent terminal 10. In the following description, in each group, each game terminal 10 that belongs to the group will be called a “member” of the group.

### 1-3. Server Device

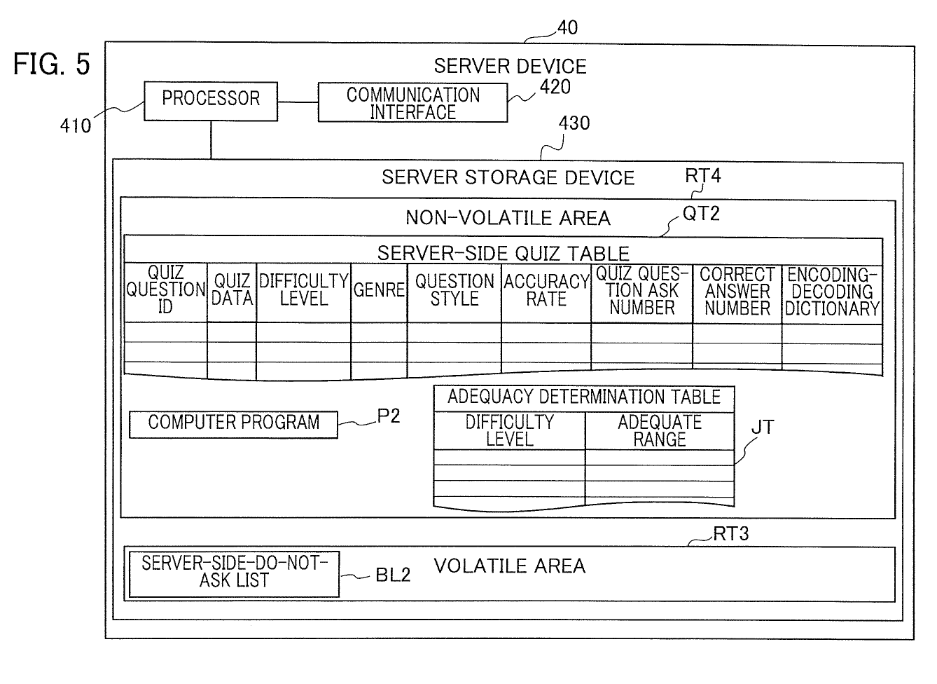

FIG. 5 is a block diagram illustrating a configuration of server device 40 included in game system 1. As shown in the figure, server device 40 has a processor 410 that performs various processes, described later, a communication interface 420 that relays data between processor 410 and router 30, and a server storage device 430 that stores various data. Processor 410 is, for example, one or plural CPUs and uses communication interface 420 to transmit data to, and receive data from, each game terminal 10.

The memory area of server storage device 430 is divided into a volatile area RT3 for which power is required for retaining the memory content and a non-volatile area RT4 for which power is not required. Volatile area RT3 can be made, for example, by a RAM and stores a server-side-do-not-ask list BL2 (question blocking data). This server-side-do-not-ask list BL2 is read from volatile area RT3 and is transmitted as terminal-side-do-not-ask list BL1 to each game terminal 10. It is to be noted that the present embodiment may be modified such that server-side-do-not-ask list BL2 is stored not in volatile area RT3 but in non-volatile area RT4. Except, the memory area for server-side-do-not-ask list BL2 must be a rewritable area.

Non-volatile area RT4 is, for example, a ROM or a hard disk. Reserved in non-volatile area RT4 is a server-side quiz table QT2 and an adequacy determination table JT. The server-side quiz table QT2 stores, for each quiz question, a quiz question ID, difficulty level data representing a difficulty level (difficulty degree) of a quiz question, genre data, question style data, accuracy rate data representing an accuracy rate (percentage of correct answers) of a quiz question, quiz question ask number data representing the number of times a quiz question is asked, correct answer number data representing the number of correct answers of a quiz question, and encoding-decoding dictionary data representing an encoding-decoding dictionary.

The ask number of a quiz question is the number of times the quiz question is asked in all the multiple-player online games played in game system 1. The number of correct answers of a quiz question is the number of times players gave a correct answer for the quiz question in multiple-player online games in the entire game system 1. The accuracy rate of each quiz question is variable and is updated in accordance with a game result. The accuracy rate of each quiz question is calculated by dividing the number of correct answers of this quiz question by the number of times this quiz question is asked. The accuracy rate of a quiz question for which the number of times the questions is asked is 0 is determined based on the difficulty level of the quiz question.

As is clear from the foregoing description, the quiz question ask number data and the correct answer number data are accuracy rate calculation mandatory data necessary for calculation of the accuracy rate (hereinafter, this will be referred to simply as “calculation mandatory data”). The number of times a quiz question is asked and the number of times a correct answer is received for the quiz question are parameters mandatory for accuracy rate calculation.

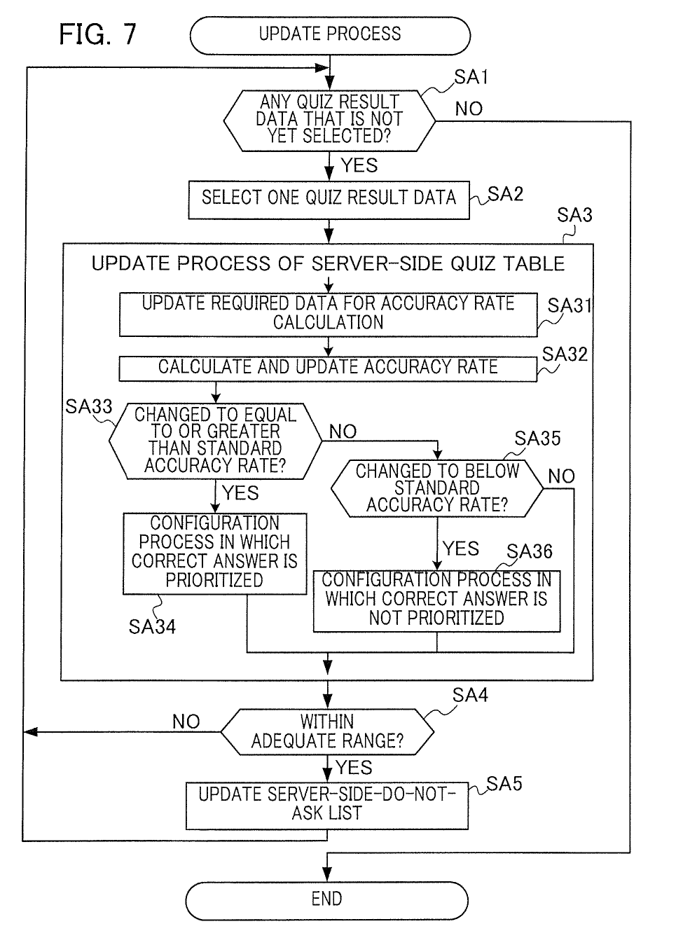

The encoding-decoding dictionary is a dictionary for encoding and decoding data in transmitting and receiving the data among members. The encoding-decoding dictionary data is data including plural sets of to-be-encoded data and encoded data. The encoding-decoding dictionary is initially configured by a process that is the same as a configuration process (described later) (Step SA36 in FIG. 7) in which the correct answer data is not prioritized and is reconfigured in an update process (described below) (FIG. 7). Although it is described below, a configuration process in which the correct answer data is prioritized is a process in which the shortest data is allocated as encoded data for to-be-encoded data corresponding to correct answer data. In contrast, a configuration process in which the correct answer data is not prioritized is a process in which the freely-selected length of data is allocated as encoded data for to-be-encoded data corresponding to correct answer data. It is to be noted that the present embodiment can be modified in such a way that quiz data sets are stored in server-side quiz table QT2 so that the server-side quiz table serves as a superset of terminal-side quiz table QT1.

When a quiz data set in server-side quiz table QT2 is manually updated, the quiz data set in terminal-side quiz table QT1 is also updated in conjunction. This data synchronization is carried out by transmitting the quiz data set from server device 40 to each game terminal 10. In a case in which there are numerous game terminals 10, it would take a considerable amount of time for the updating. Therefore, the updating should be completed during hours when game facility F is closed.

The adequacy determination table JT has stored therein, for each difficulty level (difficulty degree) of a quiz question, adequate range data representing a range (adequate range) of the accuracy rate that is adequate as the accuracy rate of a quiz question of a certain difficulty level. The adequate range of the accuracy rate is a range within which an adequate accuracy rate falls and an inadequate accuracy rate does not fall, and is predetermined. The adequate range data is for identifying a quiz question that has an accuracy rate that does not fall within the adequate range of the accuracy rate, and it can be data indicating the upper limit and the lower limit of the adequate range or can be data indicating only the lower limit of the adequate range. Because 100% is the upper limit of the accuracy rate, the data indicating only the lower limit of the adequate range is also data indicating an adequate range. It is to be noted that, because the adequate range data also shows an inadequate range of accuracy rate as the accuracy rate of a quiz question of a corresponding difficulty level, the adequate range data can also be regarded as data for identifying a quiz question that has an accuracy rate that falls within the inadequate range of the accuracy rate.

Non-volatile area RT4 stores a computer program P2. Computer program P2 includes computer-readable instructions, and when the computer program P2 is executed by processor 410, causes server device 40 to perform a server process. The server process includes a server-side grouping process for grouping plural game terminals 10, an update process for updating data stored in server storage device 430, a list delivery process for delivering terminal-side-do-not-ask list BL1 to game terminal 10, and a dictionary delivery process for delivering encoding-decoding dictionary data to game terminal 10. These processes can be executed in parallel.

### 2. Operation

### 2-1. Overview

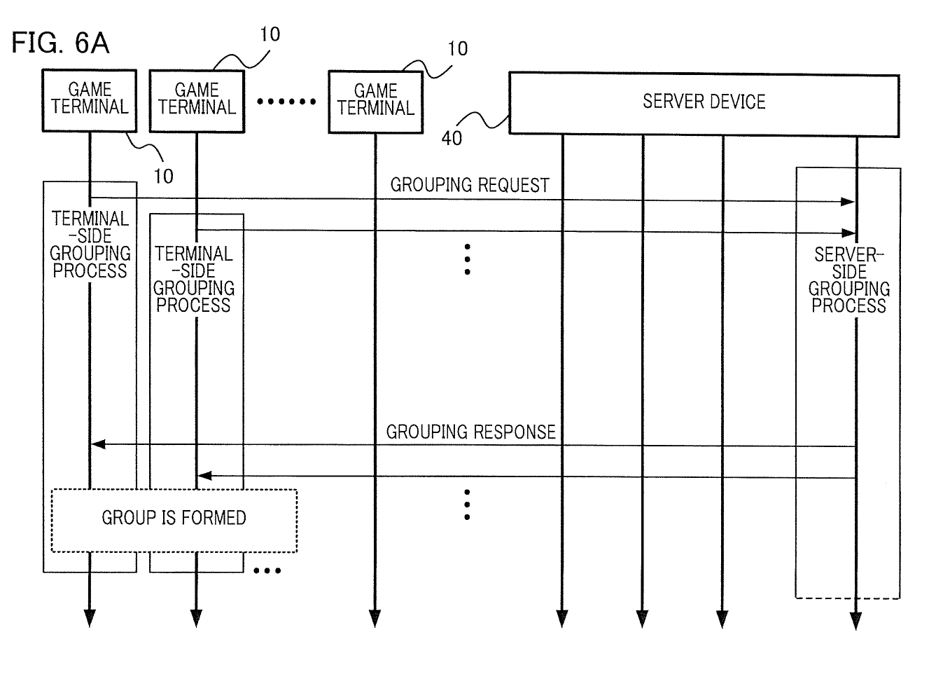

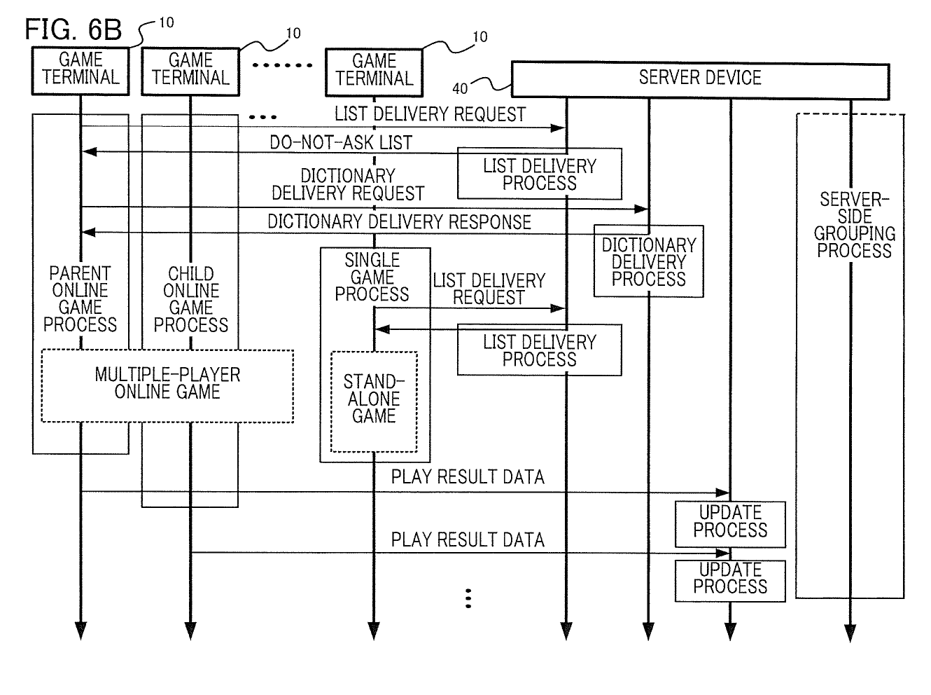

FIGS. 6A and 6B are sequence charts illustrating an operation of game system 1. FIG. 6B shows an operation that is continued from each operation of each game terminal 10 and server device 40 shown in FIG. 6A. As shown in FIGS. 6A and 6B, while game system 1 is operating, the server-side grouping process is continued at server device 40. On the other hand, as shown in FIG. 6A, at game terminal 10, a process corresponding to a type of quiz game which a player will be playing (hereinafter, this will be referred to as a “play object”). In a case in which a play object is a multiple-player online game, processor 150 of game terminal 10 first performs a terminal-side grouping process.

In the terminal-side grouping process, processor 150 first uses display unit 120 and operation unit 140, thereby to provide a UI (User Interface) for causing a player to input a play name as a name of a player for use in the multiple-player online game. The UI can be freely selected and may be, for example, a virtual keyboard. It is to be noted that the present embodiment can be modified such that a player selects one of many play names prepared in advance. Furthermore, a player may be able to use a player name that was input or selected in the past by using game terminal 10 or another device.

In the terminal-side grouping process, processor 150 first transmits, to server device 40, a grouping request for requesting grouping. On the other hand, processor 410 of server device 40 is continuously executing a server-side grouping process, and in a case in which a grouping request is received from game terminal 10, a grouping is performed for deciding game terminal 10 as the parent population. Specifically, processor 410 transmits an empty grouping response to game terminal 10 which will be a parent terminal of each group and transmits a grouping response to game terminal 10 which will be a child terminal of each group, with the grouping response including data of a communication address of game terminal 10 which will be a parent terminal of the same group. In an example shown in FIG. 6A, after a grouping request is transmitted to server device 40 from plural game terminals 10 which will belong to the same group, a grouping response is transmitted from server device 40 to these plural game terminals 10, but it is to be noted that this is merely an example.

In the terminal-side grouping process, processor 150, having received a grouping response including data representing a communication address, transmits, to game terminal 10 (parent terminal) of this communication address, play name data representing a play name input to game terminal itself (child terminal). By this process, game terminal 10, to which the play name data is transmitted, can obtain a communication address of the transmitter of the play name data. As a result, data can be transmitted and received among freely selected game terminals 10 that will belong to each group directly or indirectly via game terminal 10 that will be a parent terminal of the same group.

In the terminal-side grouping process, processor 150 of game terminal 10 that has received the play name data writes a set of the play name data and data representing the communication address of the transmitter into volatile area RT1, to transmit this set to every game terminal 10 except for game terminal 10 that has transmitted data of the same play name, from among game terminals 10 of which a communication address processor 150 has obtained. Game terminal 10 having received the set writes this data into volatile area RT1. A group is thus formed.

From among data contained in the transmitted set, data representing a communication address of the transmitter of play name data is used at the receiver of this data only for identifying the play name data. That is, the data representing the communication address is only necessary to be able to identify the play name data at the receiver side of the set. However, in a case in which data other than the data representing the communication address of a transmitter of the play name data is used, game terminal 10 that will be a parent terminal needs to know the correspondence between this other data and the data representing the communication address.

When a group is formed, a terminal-side group process is completed at each member of the group. The process relating to a play name is necessary because the play names of all the members are displayed on every screen 121 of each member of the same group. Therefore, if the present embodiment is modified so that such a display is not performed, the process associated with a play name is no longer necessary. In this case, freely selected data, instead of data representing a play name, will be transmitted from game terminal 10, which will be a child terminal to game terminal 10 that will be a parent terminal.

In a case in which the play object is a multiple-player online game, as shown in FIG. 6B, processor 150 of game terminal 10 that has finished the terminal-side grouping process performs an online game process (a parent online game process or a child online game process) corresponding to the attribute (parent or child) of its own. The details of each online game process will be described later, but just an overview is given now.

In the parent online game process, processor 150 of a parent terminal first transmits, to server device 40, a list delivery request for requesting delivery of terminal-side-do-not-ask list BL1. Processor 410 of server device 40, every time it receives the list delivery request, performs a list delivery process. That is, processor 410 reads server-side-do-not-ask list BL2 from volatile area RT3, for transmission as return as terminal-side-do-not-ask list BL1 to the transmitter of the list delivery request. Processor 150 of a parent terminal receives the transmitted terminal-side-do-not-ask list BL1 to overwrite data in volatile area RT1 with the received list and determines the details of a quiz game (a multiple-player online game in this case) based on the terminal-side-do-not-ask list BL1. Specifically, processor 150 selects the regulated number of the candidates of quiz questions to be given in a quiz game (hereinafter referred to as “candidate questions”) and determines the order of asking these candidate questions. The regulated number is a plural number equal to or greater than the maximum number of quiz questions asked in a quiz game and is predetermined.

In the parent online game process, processor 150 of the parent terminal first transmits to server device 40 a dictionary delivery request for requesting delivery of encoding-decoding dictionary data representing an encoding-decoding dictionary of the selected, prescribed candidate questions. The dictionary delivery request contains pieces of quiz question ID data of the selected, prescribed candidate questions, with these pieces of quiz question ID data being listed in the decided order of asking. Processor 410 of server device 40, every time it receives a dictionary delivery request, performs a dictionary delivery process. Specifically, processor 410 reads from server-side quiz table QT2 pieces of encoding-decoding dictionary data corresponding to the regulated number of pieces of quiz question ID data contained in the dictionary delivery request, generates a dictionary delivery response in which the pieces of encoding-decoding dictionary data are listed in the order of asking, and transmits the response to the transmitter of the dictionary delivery request. Processor 150 of a parent terminal receives the transmitted dictionary delivery response and stores, in encoding-decoding dictionary table DT, the pieces of encoding-decoding dictionary data in the dictionary delivery response in association with corresponding quiz question ID data.

On the other hand, in the child online game process, processor 150 of a child terminal first shares, with the parent terminal, the selection of plural quiz questions, the order of asking the plural quiz questions, and the encoding-decoding dictionary in a parent terminal belonging to the same group. When this sharing is completed at every child terminal of the same group, a multiple-player online game of the determined content is performed in this group.

When the multiple-player online game is finished, processors 150 of all the member game terminals 10 of the group in which the game was played each transmits to server device 40 play result data representing a result of the play of the game, to terminate the online game process. The play result data is data for each player. The play result data includes, for each and every quiz question included in a multiple-player online game that has ended, quiz result data indicating a result of a quiz (hereinafter, this will be referred to as a “quiz result”).

Processor 410 of server device 40, every time play result data is received, performs an update process. Specifically, processor 410 updates data stored in server storage device 430 in accordance with the received play result data. As a result, data such as server-side quiz table QT2 and server-side-do-not-ask list BL2 is updated. It is to be noted that the present embodiment can be modified so that a parent terminal of a group collects pieces of play result data of all the game terminals 10, for transmission to server device 40.

On the other hand, in a case in which the play object is a stand-alone type game, processor 150 of game terminal 10 performs a single game process. The details of the single game process will be described below, and just an overview is given here. In the single game process, processor 150 of game terminal 10 transmits the above-described list delivery request to server device 40. As a result, terminal-side-do-not-ask list BL1 will be transmitted from server device 40 to this game terminal 10 as a reply. Processor 150 of this game terminal 10 receives terminal-side-do-not-ask list BL1 and overwrites data in volatile area RT1 with the received list, to determine the content of a quiz game (a stand-alone type game in this case) based on terminal-side-do-not-ask list BL1. The stand-alone type game is performed at game terminal 10 under the determined content. When the stand-alone type game is completed, processor 150 of game terminal 10 ends a single game process.

### 2-2. Update Process

FIG. 7 is a flowchart illustrating an update process performed at server device 40. In the update process, quiz result data included in play result data received from game terminal 10 is selected sequentially one by one, and server-side quiz table QT2 is, or server-side quiz table QT2 and server-side-do-not-ask list BL2 are, updated based on the information of the selected quiz result data. Processor 410 of server device 40 first determines whether there is any quiz result data that is not yet selected for which an update process is not yet performed, from among plural pieces of quiz result data contained in the result data received from game terminal 10 (SA1). In a case in which a result of the determination is negative, processor 410 ends the update process.

In a case in which a result of the determination in Step SA1 is affirmative, processor 410 first selects, from among the plural pieces of quiz result data, a piece of quiz result data that has not yet been selected (SA2). Subsequently, processor 410 performs, based on the selected piece of quiz result data, an update process of server-side quiz table QT2 (SA3). The details of this update process depend on an accuracy rate, as will be described below.

In the update process of server-side quiz table QT2, processor 410 first updates calculation mandatory data based on the selected piece of quiz result data (SA31). The quiz result data is data indicating a result of a quiz question, and specifically indicates a quiz question ID of the asked quiz question and whether an answer to the question was correct.

In Step SA31, processor 410 updates quiz question ask number data and correct answer number data corresponding to a quiz question ID in the selected piece of quiz result data (hereinafter referred to as “selected quiz ID”) or quiz question ask number data corresponding to the selected quiz ID so that the number of correct answers for a quiz question having the selected quiz ID increases by 1 only when the number of times of asking the quiz question having the selected quiz ID increases by 1 and when the correct or incorrect data in the selected piece indicates that a correct answer was given, i.e., when the quiz result data indicates that an answer to the quiz question was correct.

Subsequently, processor 410 refers to server-side quiz table QT2 to calculate an accuracy rate of a quiz question having the selected quiz ID and updates accuracy rate data so that accuracy rate data indicating the accuracy rate of a quiz question of the selected quiz ID represents the calculated accuracy rate (SA32). Subsequently, processor 410 determines whether the accuracy rate of a quiz question having the selected quiz ID changes to a value equal to or greater than the predetermined standard accuracy rate as a result of the update performed in Step SA32 (SA33). That is, in a case in which the accuracy rate before the update was less than the standard accuracy rate, it is determined that the accuracy rate changes to the same as the standard accuracy rate or exceeds the standard accuracy rate through this update.

In a case in which a result of the determination in Step SA33 is affirmative, processor 410 performs a configuration process in which correct answer data is prioritized as a process of reconfiguring the encoding-decoding dictionary (SA34). Specifically, processor 410 reconfigures the encoding-decoding dictionary of the quiz question having selected quiz ID so that the shortest encoded data corresponds to to-be-encoded data of correct answer data corresponding to the selected quiz ID. The update process of server-side quiz table QT2 is thus completed. It is to be noted that the reconfiguration of the encoding-decoding dictionary means updating encoding-decoding dictionary data representing encoding-decoding dictionary.

In a case in which a result of the determination in Step SA33 is negative, processor 410 determines whether the accuracy rate of a quiz question having the selected quiz ID has changed to below the predetermined standard accuracy rate as a result of the update in Step SA32 (SA35). That is, in a case in which the accuracy rate before the update was equal to or greater than the standard accuracy rate, it is determined that the accuracy rate fell below the standard accuracy rate by this update. In a case in which a result of the determination is affirmative, processor 410 performs, as a process of reconfiguring the encoding-decoding dictionary, a configuration process in which correct answer data is not prioritized (SA36). Specifically, processor 410 reconfigures the encoding-decoding dictionary of the quiz question having the selected quiz ID so that the freely determined length of encoded data corresponds to to-be-encoded data of correct answer data corresponding to the selected quiz ID. The update process of this server-side quiz table QT2 is thus completed. On the other hand, a result of the determination in Step SA35 is negative, i.e., in a case in which there is no change between the accuracy rate before update and after update, relative to the standard accuracy rate, processor 410 ends the update process of server-side quiz table QT2.

When the update process of server-side quiz table QT2 is completed, processor 410 determines, based on the adequacy determination table JT, whether the accuracy rate of a quiz question having the selected quiz ID is not within the adequate range corresponding to the difficulty level of this quiz question (SA4). In a case in which a result of the determination is affirmative, processor 410 updates server-side-do-not-ask list BL2 (SA5). Specifically, processor 410 updates server-side-do-not-ask list BL2 so as to include quiz question ID data indicating the selected quiz ID. The process then returns to Step SA1. In a case in which a result of the determination Step in SA4 is negative, the process returns to Step SA1.

Thus, in the update process, server-side quiz table QT2 is updated based on play result data received from game terminal 10, and server-side-do-not-ask list BL2 is updated so as to include quiz question ID data indicating a quiz question ID of a quiz question for which the accuracy rate is not within the adequate range. It is to be noted that the present embodiment can be modified so that quiz question ID data indicating a quiz question ID of a quiz question for which the accuracy rate is within the adequate range is deleted from server-side-do-not-ask list BL2.

### 2-3. Single Game Process

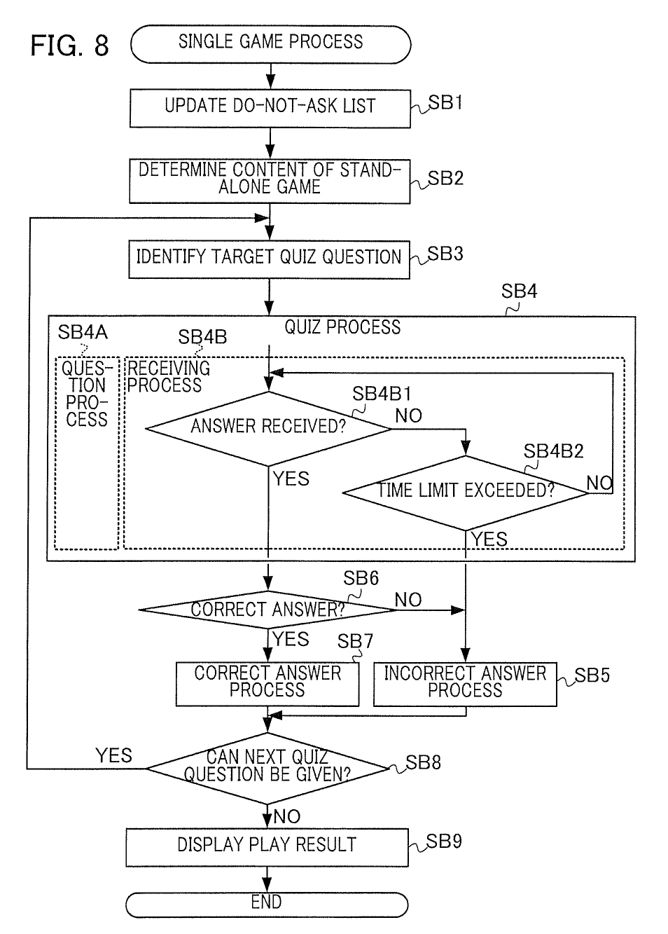

FIG. 8 is a flowchart illustrating a single game process performed at game terminal 10. In the single game process, processor 150 of game terminal 10 updates terminal-side-do-not-ask list BL1 (SB1). Specifically, processor 150 transmits a list delivery request to server device 40, receives, from server device 40, terminal-side-do-not-ask list BL1, and overwrites data in volatile area RT1 with the received terminal-side-do-not-ask list BL1.

Processor 150 then, based on terminal-side-do-not-ask list BL1, determines the content of a stand-alone type game (SB2). Specifically, processor 150 provides a UI for causing a player to specify a genre and a question style, and in a case in which the genre and the question style are specified, processor 150 defines all the questions of the specified genre and question style as a population for selecting candidates (hereinafter referred to as the “population for candidate selection”), selects from this population for candidate selection the regulated number of quiz questions identified by quiz question IDs that are not included in terminal-side-do-not-ask list BL1 as candidate questions, and determines the order of asking the selected, regulated number of candidate questions. This selection and determination are performed by using, for example, random numbers.

In a case in which the question style is not specified, the question style is automatically determined, and the population for candidate selection is defined based on the determined question style. In this case, the question style is determined by using, for example, random numbers. In a case in which a genre is not specified, all the quiz questions in the specified or determined question style will be the population for candidate selection in the above selection, and the selection of candidate questions from this population for candidate selection is performed by the association-based selection process for selecting the regulated number of candidate questions that have an association that is different from a genre.

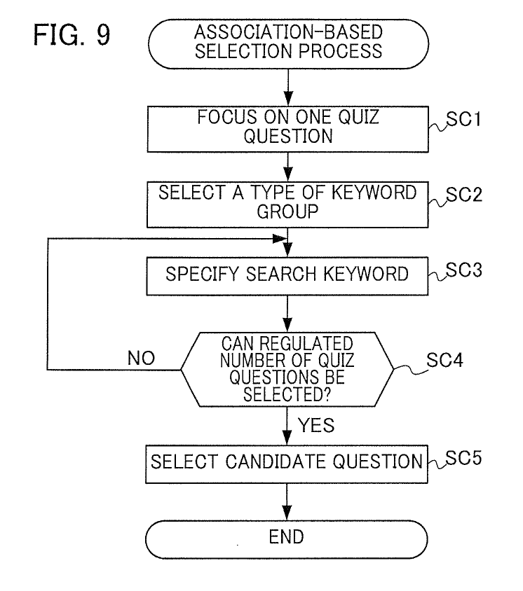

FIG. 9 is a flowchart illustrating an association-based selection process included in the single game process. In the association-based selection process, processor 150 of game terminal 10 first focuses on one quiz question that is not yet focused from the population for candidate selection (SC1). Specifically, processor 150 focuses on one piece of quiz question ID data that is not yet focused on from among pieces of quiz question ID data of terminal-side quiz table QT1. This one piece of quiz question ID data is determined by using, for example, random numbers. Subsequently, processor 150 selects, based on the specified or determined question style, a type of keyword group (SC2). For example, in a case in which the specified or determined question style is multiple-choice, processor 150 selects one of a quiz-question related keyword group, a correct-answer related keyword group, or an incorrect-answer related keyword group. The present embodiment may be modified so that plural types are selected from these keyword groups.

Subsequently, processor 150 specifies a search keyword (SC3). This specification is performed by defining, based on keyword group data in terminal-side quiz table QT1, a keyword group that is the same as the type of keyword group selected in Step SC2 as a population (hereinafter referred to as the “population for keyword selection”) from among keyword groups of a quiz question that is being focused on and by selecting from this population one keyword that has not yet been selected. This selection is performed by using, for example, random numbers. It is to be noted that the present embodiment may be modified such that plural search keywords are identified.

Subsequently, processor 150 determines whether the regulated number of quiz questions can be selected as candidate questions based on terminal-side quiz table QT1, terminal-side-do-not-ask list BL1, the search keyword, and the selected type of keyword group (SC4). Specifically, it is determined whether the population for candidate selection includes quiz questions equal to or greater than the regulated number, with the quiz question being a quiz question of the specified or determined question style, with the selected type of keyword group of the quiz question including the search keyword, and with the quiz question ID of the quiz question not being included in terminal-side-do-not-ask list BL1 (hereinafter referred to as “quiz questions that can become candidate”).

In a case in which a result of the determination in Step SC4 is negative, the process returns to Step SC3. That is, the process of Steps SC3 to SC4 is repeated until a result of the determination in Step SC4 is positive. Since each of all the keyword groups of all quiz data sets includes at least one keyword that is common to all the keyword groups, a result of the determination in Step SC4 will eventually change to be positive. In a case in which a result of the determination in Step SC4 is positive, processor 150 selects, as candidate questions, each of the regulated number of quiz questions that can become candidate (SC5), to end the association-based selection process.

The present embodiment may be modified so that, in a case in which the specified or the determined question style is multiple-choice, the sum of correct-answer related keyword group and incorrect-answer related keyword group is defined as a population for keyword selection. That is, the sum of plural types of keyword groups can be defined as the population for keyword selection. The present embodiment may be modified so that the keyword group data is prepared for each of the answer options.

As shown in FIG. 8, once the content of the stand-alone type game is determined, processor 150 then identifies a target quiz question as a quiz question to be asked in the next quiz process (SB3). Specifically, from among candidate questions that have not yet been asked, a candidate question that is first in the order of asking is regarded as a target quiz question. Processor 150 then executes a quiz process (SB4). The quiz process is a process of performing a quiz. In the quiz process, processor 150 performs a question process for asking a target quiz question by using display unit 120 (SB4A) and performs a receiving process of receiving answers from a player by using display unit 120 and operation unit 140 (SB4B). The question process and the receiving process are performed by using a quiz data set (quiz question data) for performing a quiz using quiz questions to be asked. An example of an image displayed on screen 121 is shown in FIG. 10.

FIG. 10 is a diagram illustrating an example of an image displayed on screen 121 of game terminal 10. This example illustrates a case in which the specified or determined quiz question is of the multiple-choice type. Displayed in the upper display area of screen 121 in the diagram is a character string of the target quiz question, “Which is the image of Tokyo Station?”, and displayed in the lower display area of screen 121 in the diagram are images of plural answer options AS1 to AS4. A player touches an area on screen 121 that is occupied by the image of a desired answer option, thereby selecting the answer option, i.e., to answer the quiz question to be asked.

In the receiving process, processor 150 determines whether an answer from a player is received (SB4B1), and in a case in which a result of the determination is negative, processor 150 determines whether the length of time that has elapsed from the start of the receiving process has exceeded the time limit (SB4B2). In a case in which a result of the determination is negative, processor 150 returns the process to Step S4B1. In short, until an answer of a player is received (until a player gives an answer), or until the elapsed time exceeds the time limit, processor 150 waits for an answer from the player.

The time limit is a predetermined certain length of time for limiting a period for receiving an answer (selectable period) and is, for example, 60 seconds. An image displayed on screen 121 includes an image representing the remaining period until the elapsed time exceeds the time limit (“09 seconds” in FIG. 10). It is to be noted that in the present embodiment, the start of the receiving process is the same as the start of the quiz process, but the receiving process may be started after the quiz process is started.

Processor 150, in a case in which a result of the determination in Step SB4B1 or Step SB4B2 of the receiving process is affirmative, terminates the quiz process to perform the next process. Specifically, in the case of terminating the quiz process after a result of the determination in Step SB4B2 is positive, i.e., in the case of terminating the quiz process by the elapsed time exceeding the time limit, processor 150 performs an incorrect answer process (SB5). Specifically, processor 150 performs a process of displaying on screen 121 an image for informing a player that the answer is incorrect, a process for emitting from speaker 131 of sound emitter 130 a sound for informing the player that the answer is incorrect, and a process of initializing the number of consecutive correct answers.

On the other hand, in a case in which the quiz process is terminated by a result of the determination in Step SB4B1 becoming affirmative, i.e., in case in which the quiz process is terminated by an answer being received, processor 150 determines whether the received answer is correct based on the received answer and correct answer data contained in a quiz data set for performing a quiz in which a target quiz question is used (SB6). In a case in which a result of the determination is negative, the process proceeds to Step SB5. In a case in which a result of the determination is affirmative, processor 150 performs a correct answer process (SB7). Specifically, processor 150 performs a process for displaying on screen 121 an image informing a player that the answer is correct, a process for emitting from speaker 131 of sound emitter 130 a sound for informing that the answer is correct and a process of updating consecutive correct answer count data C so that the number of consecutive correct answers increases by 1.

Processor 150, having completed the correct answer process or the incorrect answer process, determines whether the next quiz question can be given (SB8). The content of this determination should be determined as appropriate in accordance with the specifications of a quiz game. For example, in a case in which a quiz game is a game terminated after the quiz process is performed for a certain number of times, processor 150 can determine whether the number of completed quiz processes reaches a certain number of times. As another example, in a case in which a quiz game is a game that is terminated within a certain length of time, processor 150 can determine whether the length of time that has elapsed from the start of a quiz game is equal to or exceeds the time limit.

In a case in which a result of the determination in Step SB8 is positive, the process returns to Step SB3. In other words, the process of Steps SB3 to SB8 is repeated until a result of the determination in Step SB8 turns negative. It is to be noted that, since the regulated number is a number that is equal to or greater than the maximum number of quiz questions given in a quiz game, quiz questions to be asked will not be in short supply. On the other hand, in a case in which a result of the determination in Step SB8 is negative, processor 150 uses display unit 120 to cause a result of the play to be displayed on screen 121 (SB9), to terminate the single game process.

### 2-4. Parent Online Game Process

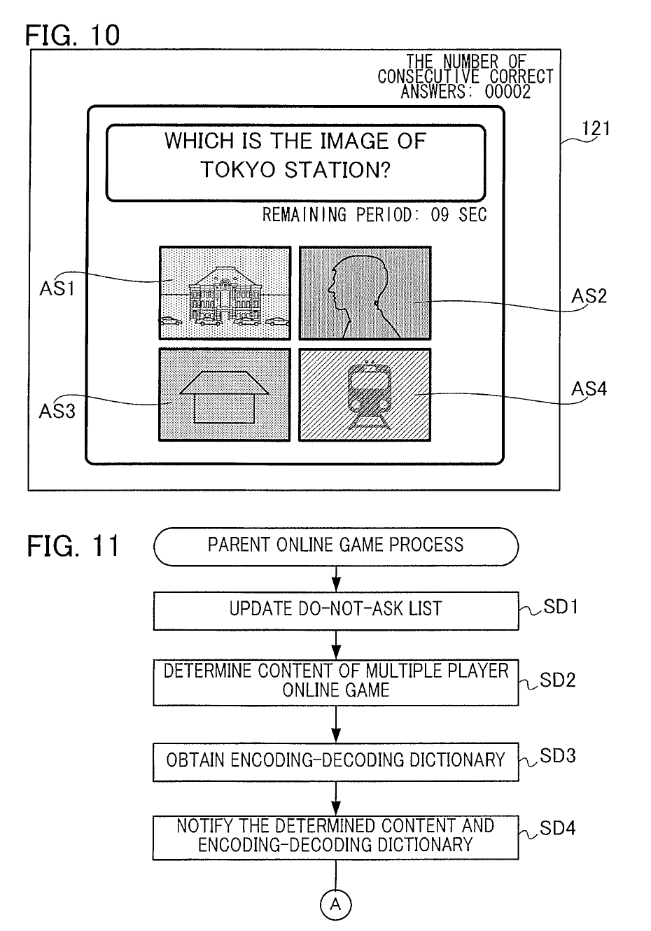

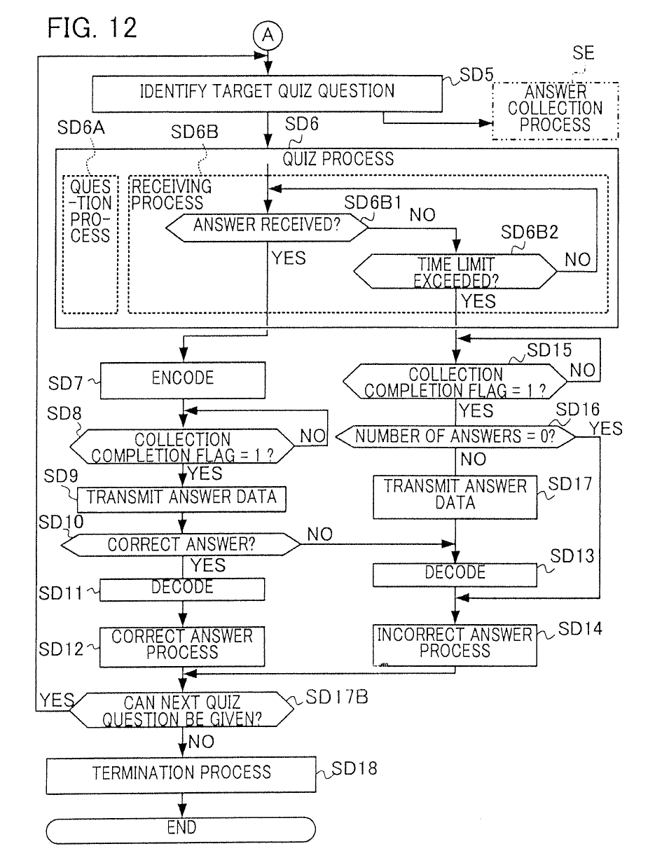

FIGS. 11 and 12 are diagrams each illustrating a part of a flowchart of a parent online game process performed at game terminal 10. In the parent online game process, processor 150 of a parent terminal updates terminal-side-do-not-ask list BL1 (SD1). This process is the same as Step SB1 in FIG. 8.

Subsequently, processor 150, based on terminal-side-do-not-ask list BL1, determines the content of a multiple-player online game (SD2). This process is the same as Step SB2, except that in Step SD2 processor 150 does not provide a UI for causing a player to specify a genre or a question style. Instead, processor 150 automatically determines the genre and the question style, or only the question style.

Subsequently, processor 150 obtains the encoding-decoding dictionary (SD3). Specifically, processor 150 first initializes the encoding-decoding dictionary table DT and then transmits, to server device 40, a dictionary delivery request for requesting a dictionary which has the content in accordance with the regulated number of candidate questions selected in Step SD2. Subsequently, processor 150 receives a dictionary delivery response which is transmitted from server device 40 as a reply, to store, in the encoding-decoding dictionary table DT, the regulated number of pieces of encoding-decoding dictionary data in the received dictionary delivery response and the regulated number of pieces of quiz question ID data in the transmitted dictionary delivery request in a correlated manner, one to one, based on the listed position of the questions IDs. It is to be noted that initializing the encoding-decoding dictionary table DT means deleting all pieces of data from encoding-decoding dictionary table DT.

Subsequently, processor 150 notifies, to every other member, the details of the determination in Step SD2 and the encoding-decoding dictionary obtained in Step SD3 (SD4). Specifically, processor 150 transmits, to every other member, the pieces of quiz question ID data of the selected, regulated number of candidate questions, data indicating the order of asking these candidate questions, and pieces of encoding-decoding dictionary data representing encoding-decoding dictionaries of these candidate questions. Processor 150 then identifies a target quiz question as a quiz question to be asked in the subsequent quiz process (SD5). The multiple-player online game is started before Step SD5 at the parent terminal.

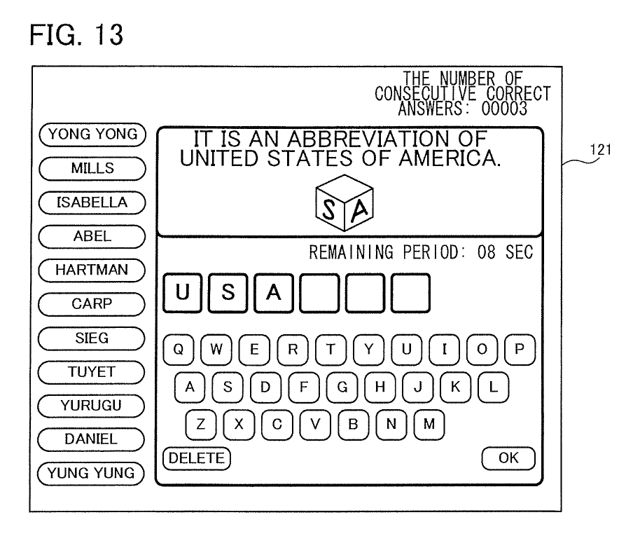

Processor 150 then performs the quiz process (SD6) and an answer collection process of collecting answers received by other members (SE). These processes are performed in parallel with each other. The quiz process in Step SD6 is the same as the quiz process in Step SB4. An example of an image displayed on screen 121 in this quiz process is illustrated in FIG. 13.

FIG. 13 is a diagram illustrating an example of an image displayed on screen 121 of game terminal 10. In this example, the determined question style is of the type-in style, in which a target quiz question is displayed on a display area of the upper portion of the figure in screen 121, and a virtual keyboard is displayed on a display area of the lower portion of the figure in screen 121. The target quiz question includes character strings, “It is an abbreviation of ‘The United States of America’.” and an image of a rotating cube. Each surface of this cube has a character-by-character depiction of every character contained in “USA”, which is the correct answer. A player looks at the character strings of the target quiz question and the image to think of the character string of an answer, inputs the character string of the answer by inputting the characters one by one by touching an area occupied by a desired key of the virtual keyboard, and touches an area occupied by a predetermined key (“OK” key in the figure), thus answering the quiz question to be asked. The character string of the input answer is displayed on a display area of a nearly central portion of the figure on screen 121. Furthermore, the play names of players who are using the members other than this game terminal are displayed in an area of the left portion of the figure in screen 121. It is to be noted that the Delete key in the figure is a key for deleting one character input most recently from among the characters in the input character string.

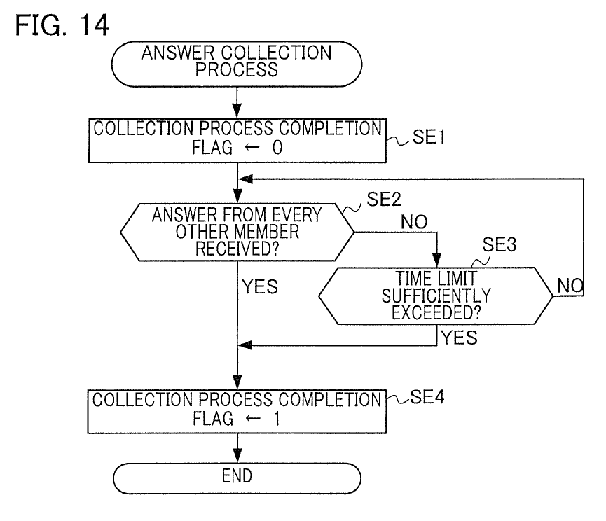

FIG. 14 is a flowchart illustrating an answer collection process included in the parent online game process. The answer collection process commences simultaneously with a process corresponding to Step SB4B2 (SD6B2). In the answer collection process, processor 150 first reserves, in volatile area RT1, a collection process completion flag FL indicating whether a process of collecting answers received at other members has been completed and sets the value as 0 (not yet completed) (SE1).

Subsequently, processor 150 determines whether it has received answer data representing an answer from every other member (SE2), and in a case in which a result of the determination is negative, processor 150 determines whether the length of time that has elapsed from the start of the receiving process has sufficiently exceeded the time limit (SE3). In a case in which a result of the determination is negative, processor 150 returns the process to Step SE2. That is, processor 150 waits for answer data from other members until it receives answer data from every other member or the elapsed time has sufficiently exceeded the time limit.

Once a result of the determination in Step SE2 or SE3 turns affirmative, processor 150 changes the value of collection process completion flag FL in volatile area RT1 to 1 (completed) (SE4), to end the answer collection process. In the present embodiment, the result of the determination in Step SE3 will not become affirmative only by the elapsed time exceeding the time limit, so as to prevent the failure to collect answer data due to process delay and communication delay.

In the quiz process (SD6) in FIG. 12, processor 150, in a case in which a result of the determination in a process (SD6B1) corresponding to Step SB4B1 turns positive, or a result of the determination in a process (SD6B2) corresponding to Step SB4B2 turns positive, terminates the quiz process to perform the next process. Specifically, processor 150, in the case of terminating the quiz process by receiving an answer (SD6B1; YES), refers to the encoding-decoding dictionary of the target quiz question, to encode answer data representing this answer (SD7).

Subsequently, processor 150 determines whether the collection process completion flag FL is 1 (completed) (SD8). In a case in which a result of the determination is negative, the process returns to Step SD8. In other words, processor 150 waits for a process of collecting answers received at other members to be completed. Processor 150 then, to every other member, transmits its own answer data and collected pieces of answer data (SD9). Every piece of answer data has been encoded. It is to be noted that the present embodiment may be modified so that transmission of answer data is omitted in a case in which the destination of the answer data is a member from which the answer data was collected.

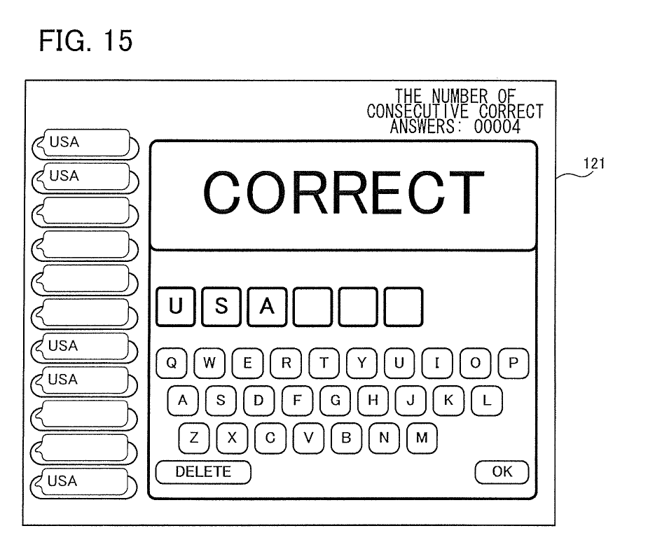

Subsequently, processor 150 determines whether, based on the answer received at this game terminal and on correct answer data included in the quiz data set for performing a quiz using the target quiz question, the answer is correct (SD10). In a case in which a result of the determination is positive, processor 150 refers to the encoding-decoding dictionary of the target quiz question, to decode each collected piece of answer data (SD11). Processor 150 then performs a correct answer process that is the same as that of Step SB7 (SD12), except that in this correct answer process, processor 150 uses display unit 120 to display on screen 121 not only the answer received by this game terminal, but also answers received by other members. FIG. 15 illustrates an example of an image displayed on screen 121 in this process.

FIG. 15 is a diagram illustrating an example of an image displayed on screen 121 of game terminal 10. This example illustrates a case in which the determined question style is of the type-in style. As it is clear when compared with FIG. 13, the answers of players who are using the member terminals except for this game terminal are displayed in an area in the left portion of the figure in screen 121 in FIG. 15. These answers are displayed in a manner in which it shows which answer is the answer of which player.

On the other hand, in a case in which a result of the determination in Step SD10 is negative, processor 150 refers to the encoding-decoding dictionary of the target quiz question, to decode each collected piece of answer data (SD13), and performs an incorrect answer process that is the same as Step SB5 (SD14). However, in this incorrect answer process, processor 150 uses display unit 120 to display in screen 121 not only the answer received by this game terminal but also the answers received by other members. These answers are displayed in a manner showing which answer is the answer of which player.

On the other hand, in a case in which the quiz process was terminated by a result of the determination in Step SD6B2 turning positive, i.e., the quiz process was terminated by the elapsed time exceeding the time limit, processor 150 first determines whether the collection process completion flag FL is 1 (completed) (SD15). In a case in which a result of the determination is negative, the process returns to Step SD15. In other words, processor 150 waits until a process of collecting answers received by the other members is completed. Subsequently, processor 150 determines whether the number of collected answers (answer data) is 0 (SD16). A result of this determination turns affirmative only in a case in which no answer was received by any of the members.

In a case in which a result of the determination in Step SD16 is negative, processor 150 transmits, to every other member, its own answer data and the collected answer data (SD17). This process is the same as the process in Step SD9. The process then advances to Step SD13. On the other hand, in a case in which a result of the determination in Step SD16 is affirmative, the process advances to Step SD14. That is, in a case in which an answer was not received at any of the members, transmission of answer data (S17) and decoding of answer data (S13) are skipped.

Processor 150, having finished a correct answer process or an incorrect answer process, determines whether the next quiz question can be given (SD17), and in a case in which a result of the determination is positive, the process returns to Step SD5. That is, until a result of the determination in Step SB17 turns negative, the process from Steps SD5 to SD17 (and the answer collection process (SE)) is repeated. On the other hand, in a case in which a result of the determination in Step SB8 is positive, processor 150 performs a termination process of terminating the parent online game process (SD18), to end the parent online game process. A multiple-player online game ends before the termination process at the parent terminal.

In this termination process, processor 150 uses display unit 120 to display a result of the play on screen 121 and transmits, to server device 40, play result data representing a result of the play of a player who is using this game terminal with respect to a multiple-player online game, which has ended.

In generating this play result data, processor 150 generates pieces of quiz result data for each of quiz questions included in the multiple-player online game, which has ended. From among these pieces of quiz result data, a piece of quiz result data indicating that the answer was correct is always a piece of quiz result data for a quiz question for which a result of determination in Step SD10 became positive.

### 2-5. Child Online Game Process

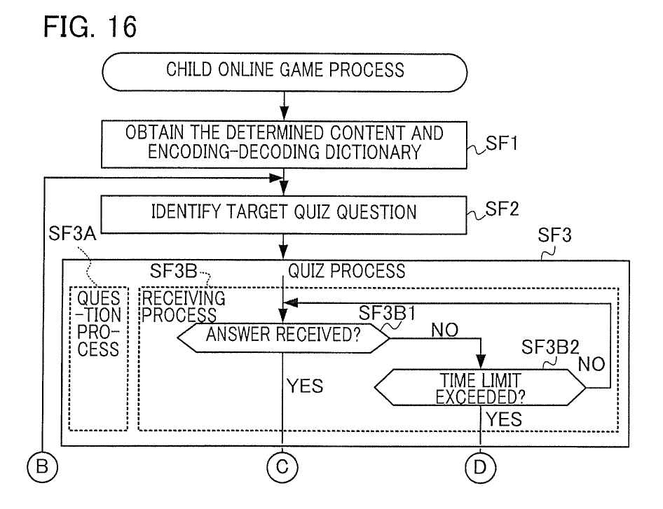

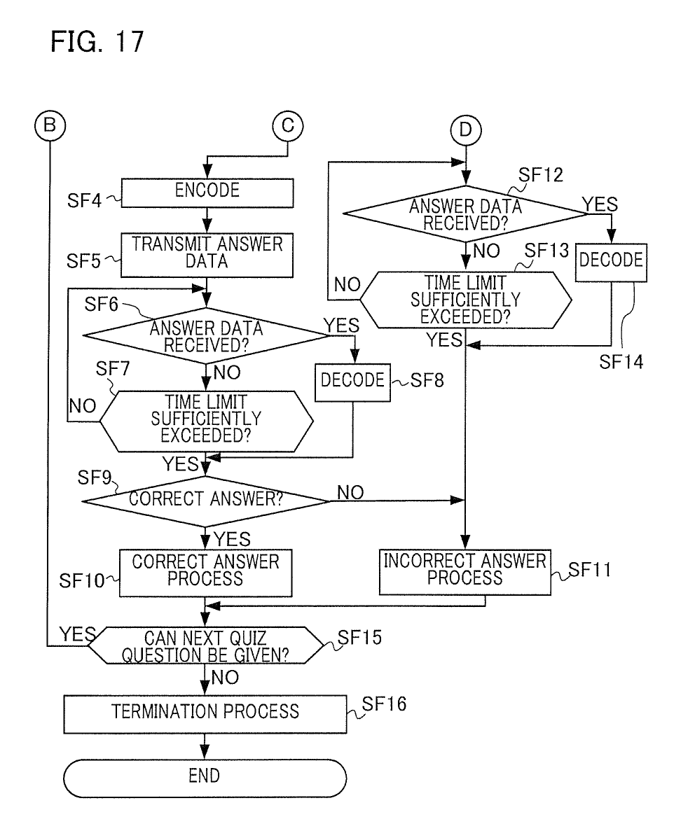

FIGS. 16 and 17 are diagrams each illustrating a part of a flowchart of a child online game process performed at game terminal 10. In the child online game process, processor 150 of a child terminal first obtains, from a parent terminal of the same group, the content of a multiple-player online game and the encoding-decoding dictionary (SF1). Specifically, pieces of quiz question ID data of the regulated number of candidate questions selected at the member parent terminal, data representing the order of asking these candidate questions, and encoding-decoding dictionary data representing the encoding-decoding dictionary of these candidate questions are received from the parent terminal.

Subsequently, processor 150 identifies a target quiz question which is a quiz question to be given in the next quiz process (SF2). A multiple-player online game starts at a child terminal before Step SF2. Processor 150 then performs a quiz process (SF3). The quiz process in Step SF3 is the same as the quiz process in Step SB4. In Step SF3, an image that is the same as the image shown in FIG. 13 is displayed on screen 121. In the quiz process in Step SF3, processor 150 terminates the quiz process in a case in which a result of the determination in a process (SF3B1) corresponding to Step SB4B1 or a result of the determination in a process (SF3B2) corresponding to Step SB4B2 becomes affirmative, to perform the next process.

In a case of terminating the quiz process by receiving an answer, processor 150 refers to the encoding-decoding dictionary of the target quiz question, to encode answer data representing the answer (SD4). Subsequently, processor 150 transmits, to the member parent terminal, the encoded answer data of this game terminal (SD5). Processor 150 then determines whether it has received answer data from the member parent terminal (SF6), and in a case in which a result of the determination is negative, processor 150 determines whether the length of time that has elapsed from the start of the receiving process in Step SF3B has sufficiently exceeded the time limit (SF7). In a case in which a result of this determination is negative, the process returns to Step SF6.

Processor 150, in a case in which a result of the determination in Step SF6 turns affirmative by receiving answer data from the member parent terminal, refers to the encoding-decoding dictionary of the target quiz question, to decode every received answer data (SF8). Processor 150 then determines whether its own answer is correct based on its own answer data of and correct answer data contained in the quiz data set for performing a quiz using the target quiz question (SF9). On the other hand, in a case in which a result of the determination in Step SF7 turns positive by the elapsed time having sufficiently exceeded the time limit, the process advances to Step SF9.

In a case in which a result of the determination in Step SF9 turns positive, processor 150 performs a correct answer process that is the same as Step SD12 in FIG. 12 (SF10). On the other hand, in a case in which a result of the determination in Step SF9 turns negative, processor 150 performs an incorrect answer process that is the same as Step SD14 in FIG. 12 (SF11). On the other hand, in the case of terminating the quiz process by the elapsed time exceeding the time limit, processor 150 performs the same process as Steps SF6 to SF8 (SF12 to SF14). When this process is completed, the routine advances to Step SF11.

Processor 150, having completed the correct answer process or the incorrect answer process, determines whether the next quiz question can be given (SF15), and in a case in which a result of the determination is affirmative, the process returns to Step SF2. In other words, the process from Steps SF2 to SF15 is repeated until a result of the determination in Step SF15 becomes negative. On the other hand, in a case in which a result of the determination in Step SF15 is affirmative, processor 150 performs the same termination process (SF16) as the above-described terminal process (SD18), to terminate the child online game process. In the termination process of Step SF16, from among pieces of quiz result data included in the multiple-player online game, which has ended, a piece of quiz result data indicating that an answer was correct is always a piece of quiz result data for a quiz for which a result of the determination in Step SF9 became positive.

It is to be noted that the multiple-player online game ends at a child terminal before the termination process.

### 3. Effects

In the following, description will be given of the effects that can be attained by the present embodiment. It is to be noted that, if any of the effects that will be described in the following is not necessary, an element other than an element for bringing about a necessary result may be removed from game system 1.

In the present embodiment, game terminal 10 has processor 150 and terminal storage device 160, and there are stored in terminal storage device 160, for each quiz question, keyword group data representing a keyword group including plural keywords, quiz question data representing the quiz question, correct answer data representing a correct answer of the quiz question, and genre data indicating a genre of the quiz question. Processor 150, by using computer program P1 stored in terminal storage device 160, performs a process (SB4B, SD6B) of receiving an answer from a player in each quiz, a process (SB6, SD10) of determining whether an answer received in each quiz is correct by using correct answer data representing a correct answer of a quiz question given in the quiz, a process (SC3) of dynamically specifying one search keyword, a process (SC5) of selecting plural quiz questions having association with one another by selecting plural quiz questions for each of which keyword group data representing a keyword group that includes the search keyword is stored in terminal storage device 160, and a process (SB4A, SD6A) of giving the selected plural quiz questions in one quiz game, by using quiz question data representing each quiz question.

Thus, at game terminal 10, one search keyword is dynamically specified in each quiz game, and plural quiz questions that are associated by the specified search keyword are given to a player. Therefore, according to game terminal 10, the associations among plural quiz questions that are given to a player can be used as a game element, so that the game-worthiness of a quiz game can be increased.

Furthermore, at game terminal 10, because neither quiz question data or correct answer data is concurrently used as keyword group data, the freedom in data format of quiz question data or correct answer data does not have to be reduced. For example, data representing an image can be quiz question data.

Furthermore, in the present embodiment, there are plural types of keyword groups corresponding to each quiz question, and the plural types of keyword groups each contains a keyword that is related to a quiz element that is different from group to group. Processor 150 of game terminal 10 uses computer program P1 stored in terminal storage device 160, to perform a process (SC2) of selecting one of the plural types. Also, quiz questions selected in a process (SC5) of selecting plural quiz questions are limited to a quiz question that includes the specified search keyword and to a quiz question for which keyword group data representing the selected type of keyword group is stored in terminal storage device 160. Therefore, by use of game terminal 10, a question as to which quiz element is focused on in associating the plural quiz questions can also be a game element, and the game-worthiness of a quiz game can be further enhanced.

Additionally, in the present embodiment, there is stored in terminal storage device 160, for each quiz question, genre data indicating a genre of a quiz question separately from keyword group data, and processor 150 of game terminal 10 performs a process (SB2, SD2) of specifying one genre, a process (SB2, SD2) of selecting plural quiz questions for which genre data representing the identified genre is stored in terminal storage device 160, and a process (SB4A, SD6A) of giving a player the selected plural quiz questions in one quiz game, by using quiz question data representing each quiz question. Therefore, according to game terminal 10, in each quiz game, plural quiz questions that are associated with one another can be given to a player, the association relating to something other than a genre, and moreover, the plural quiz questions that are selected from the specified one genre can be selected.

In the present embodiment, at each game terminal 10, processor 150 performs a process of asking a quiz question and receiving an answer to the question and a process of generating quiz result data indicating a question ID of the asked quiz question and whether the answer to the question was correct for transmission to server device 40. At server device 40, which has stored therein, for each quiz question, calculation mandatory data (ask number data and correct number data), processor 410 performs a process of receiving quiz result data from each game terminal 10, a process of updating, based on the received quiz result data, calculation mandatory data for a quiz question of a quiz question ID indicated by the quiz result data (SA31), a process of calculating an accuracy rate of a quiz question of the updated calculation mandatory data by using the calculation mandatory data (SA32), a process of determining whether the calculated accuracy rate is outside a predetermined adequate range (SA4), and a process of transmitting, to each game terminal 10, a do-not-ask list including quiz question ID data indicating a quiz question ID for which a result of the determination is positive. At each game terminal 10, processor 150 performs a process of receiving the do-not-ask list and updating terminal-side-do-not-ask list BL1 (SD1) and a process of determining, based on the updated terminal-side-do-not-ask list BL1, a quiz question to be asked in a quiz (SD2). Therefore, according to the present embodiment, asking a quiz question for which the latest accuracy rate does not fall within an adequate range can be blocked.

An inadequate quiz question to be asked is a quiz question for an erroneous quiz. Because, in the erroneous quiz, an answer based on correct knowledge will be a wrong answer, the accuracy rate of an inadequate quiz question to be asked will be extremely low. Therefore, according to the present embodiment, by determining an appropriate adequate range, it is possible to reliably detect an inadequate quiz question to be asked and to block the asking of such a question.

Furthermore, in the present embodiment, there is stored, in server storage device 430 of server device 40, for each quiz question, difficulty level data indicating a difficulty level of the quiz question. An adequate range of accuracy rate for quiz question is determined in advance depending on the difficulty level thereof, and asking can be blocked of a quiz question for which the latest accuracy rate falls outside an adequate range determined in advance depending on the difficulty level of a quiz question. Thus, because an adequate range of accuracy rate is determined depending on the difficulty level of a quiz question, more reliable and speedy detection of an inadequate question to be asked is possible according to the present embodiment.

In the present embodiment, question ID data is used to block the asking of a quiz question. Therefore, asking of an inadequate question to be asked can be blocked without requiring time-consuming operations such as deleting, adding, and updating a quiz question data at each game terminal 10. Furthermore, because the data size of a quiz question ID is usually smaller than the size of quiz question data, the amount of communication between server device 40 and each game terminal 10 can be reduced.

### 4. Modifications

The above embodiment may be modified as described in the following.

### 4-1. Modification for Encoding-Decoding Dictionary

### 4-1-1. Modification 1

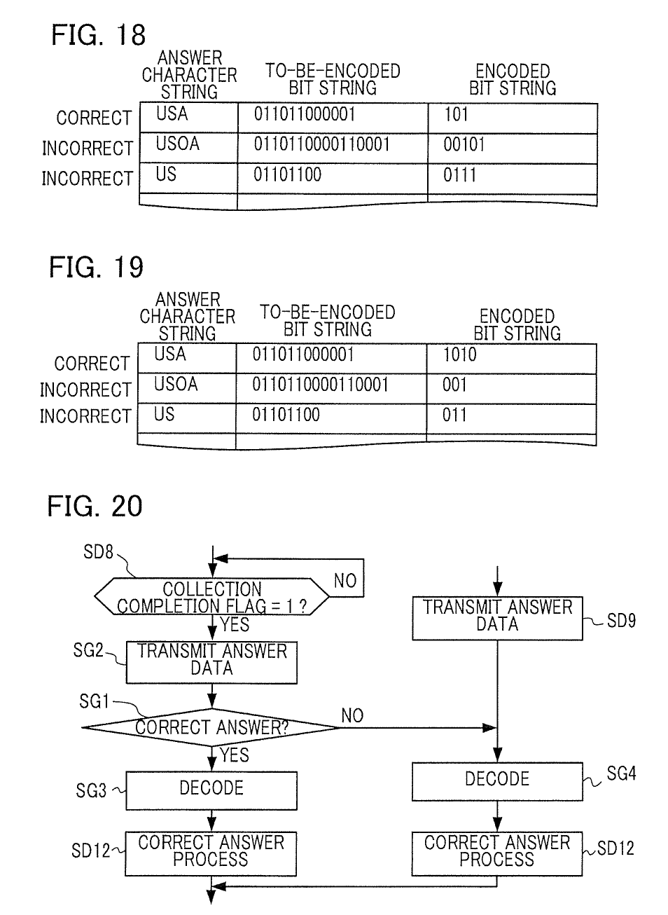

For example, as illustrated in FIG. 18, the encoding-decoding dictionary may be configured such that, for each quiz question, from among the first bit of each piece of encoded data of encoding-decoding dictionary data, only the first bit of encoded data corresponding to to-be-encoded data which is the same as the correct answer data has the particular value (“1” in the figure). In a case in which the encoding-decoding dictionary is thus configured, the encoding-decoding dictionary may be configured such that, from among pieces of encoded data contained in each encoding-decoding dictionary data, encoded data that is different from encoded data corresponding to to-be-encoded data which is the same as the correct answer data is the shortest, as shown in FIG. 19.

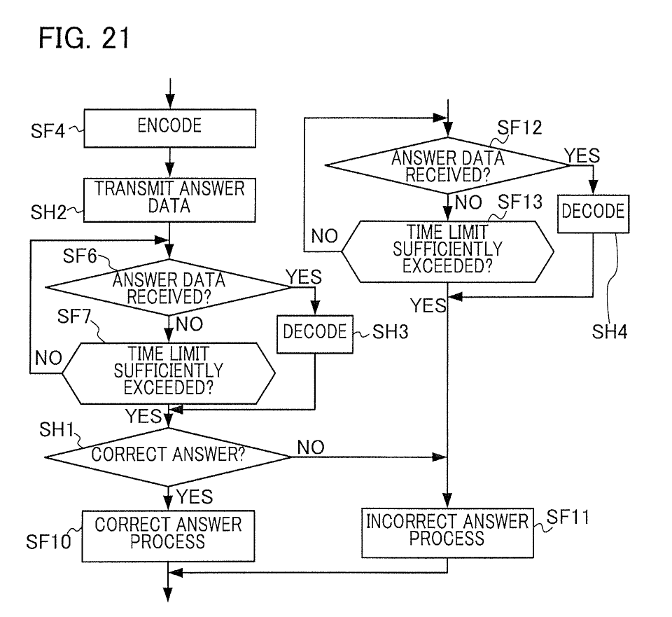

By configuring the encoding-decoding dictionary as shown in FIG. 18 or FIG. 19, it is possible to provide a game system in which only the first bit of encoded answer data has to be transmitted in a case in which answer data to be exchanged among members is correct answer data. FIG. 20 illustrates a part of a flowchart of the parent online game process performed by a parent terminal in this mode; and FIG. 21 shows a part of a flowchart of the child online game process performed by a child terminal in this mode. Those parts that are not illustrated in FIG. 20 or 21 are the same as those in FIGS. 12 and 17.

In this mode, only the first bit of encoded answer data has to be referred to in order to determine whether an answer is correct (Step SG1 in FIG. 20, Step SH1 in FIG. 21). Furthermore, in this mode, in a case in which answer data representing an answer received by a child terminal is correct answer data, the child terminal transmits, to the member parent terminal, only the first one bit of encoded answer data instead of transmitting the encoded answer data itself (Step SH2 in FIG. 21), and correct answer data can be obtained at the parent terminal by decoding the one bit (Step SG3 in FIG. 20 and Step SG4 in FIG. 20). The same can be said of answer data representing an answer received at a parent terminal (Step SG2 in FIG. 20, Step SH3 in FIG. 21, Step SH4 in FIG. 21).

### 4-1-2. Modification 2

The encoding-decoding dictionary of a quiz question may be configured, for example, by including, in quiz result data contained in play result data transmitted from game terminal 10 to server device 40, answer data representing an answer received at game terminal 10 for a quiz question having the quiz question ID within the set and by, at server device 40, associating short encoded data with to-be-encoded data that is the same as answer data representing an answer that has a high frequency of being input and associating long encoded data with to-be-encoded data that is the same as answer data representing an answer that has a low frequency of being input. In short, the encoding-decoding dictionary of a quiz question may be reconfigured so that the length of encoded data will be a length depending on the input frequency of an answer to this quiz question. The encoding-decoding dictionary of a quiz question may thus be configured in a case in which the accuracy rate of the quiz question is less than the standard accuracy rate, or regardless of the accuracy rate of the quiz question.

4-2. Modifications for Association among Plural Quiz Questions

### 4-2-1. Modification 3

For example, for a quiz question for which the number of times the quiz question is asked exceeds a certain number, the accuracy rate that is calculated when the number of times the quiz question is a certain number may be maintained. In this case, by setting the certain number as appropriate, a situation is prevented from occurring in which the accuracy rate of the quiz question increases by the same player repeatedly answering the same quiz question.

### 4-2-2. Modification 4

For example, in a case in which some or all of the pieces of quiz question data is data representing a character string, the some or all of the pieces of the quiz question may be used as keyword group data. In short, quiz question data may concurrently serve as a quiz-question related keyword group data. Furthermore, the above some or all of the pieces of quiz question data may be limited to data representing a character string that is displayed on screen 121. Furthermore, the same modifications as these modifications may be made to various types of keyword group data.

### 4-3. Modifications for Prohibiting the Asking of Inadequate Questions to be Asked

### 4-3-1. Modification 5

For example, server device 40 may transmit each of plural game terminals 10 data instructing deletion of quiz question data of a quiz question for which the accuracy rate does not fall within an adequate range, so that each of plural game terminals 10 can delete quiz question data in accordance with the data from server device 40. The terminal-side-do-not-ask list is not necessary in this case.

Furthermore, for example, quiz question data of a quiz question which game terminal 10 is caused to ask may be transmitted from server device 40 to game terminal 10 for each quiz question. In this case, it may be further modified so that server device 40 does not transmit quiz question data of a quiz question for which the accuracy rate does not fall within the adequate range.

### 4-3-2. Modification 6

For example, an adequate range can be determined for each quiz question or may be determined as having the same range for all the questions. Also, for example, the number of quiz questions asked in one quiz game may be one. Furthermore, for example, a quiz data set does not have to be stored in server-side quiz table QT2. For example, the updating of a quiz data set at each game terminal 10 may be performed by a human going to a place at which each game terminal 10 is located.

### 4-4. Other Modifications

For example, the content of the quiz game may be dynamically controlled. Specifically, a parent terminal may select, during a multiple-player online game and for every quiz process, a target quiz question from the regulated number of candidate questions, and notifies a result of this selection to every child terminal which is a member, and every member gives a player the target quiz question in a subsequent quiz process in accordance with the notification. If this mode is adopted, it is possible to perform control such that, for example, a quiz question having relatively low difficulty level or having relatively high accuracy rate is determined to be a quiz question for the final quiz in a case in which all players participating in a multiple-player online game have given incorrect answers for all the questions so far and are coming up to the final quiz, if the regulated number is determined to be sufficiently large. According to this control, there will be a lower probability of impairing game-worthiness. Furthermore, the probability is reduced of the occurrence of situations in which the player satisfaction is extremely low (no correct answer).

For example, the game system may have a configuration in which freely-selected game terminals do not have a parent-child (master-client) relationship, but communicate with one another on an equal basis. In this case, the communication address of each member is shared by all the members. Furthermore, for example, a home-use game console may be used as game terminal 10. In this case, game terminal 10 is placed in households. Also, for example, a portable type game device may be used as game terminal 10. In this case, game terminal 10 is carried by a player.

In the above embodiment, description was given of a case in which computer program P2 is executed by processor 410 of server device 40, but by executing the computer program by a general-use computer, the processor of the computer may be caused to execute the process of each of the above-described embodiments.

Additionally, in the above embodiment, description was given of a case in which computer program P2 is stored in non-volatile area RT4 of server storage device 430 in server device 40, but the computer program may be recorded, as data loadable onto a memory of a computer, on a data carrier such as a floppy (registered trademark) disk, a CD-ROM, or any other computer-readable recording medium and be distributed. The data carrier may be a data connection, such as for transmitting signals representing computer program P1 via a telephone line or a wireless connection. For example, computer program P1 may be downloaded through communication interface 180 by connecting to the Internet 2.

1. A game system for enabling a player to play a quiz game including a quiz, comprising:
plural game terminals; and
a server device,
each of the plural game terminals comprising:
a question blocking data receiver that receives, from the server device, question blocking data for blocking a particular quiz question from being asked;
a quiz question decider that decides a quiz question to be asked in the quiz based on the question blocking data received by the question blocking data receiver;
a questioner that, in the quiz, asks the player the quiz question decided by the quiz question decider;
an answer receiver that, in the quiz, receives an answer to the quiz question asked by the questioner;
an answer determiner that determines whether the answer received by the answer receiver is correct; and
a quiz result data transmitter that generates quiz result data indicating an identifier of a quiz question for which an answer is received by the answer receiver and also indicating whether the answer received was found to be correct and that transmits the generated quiz result data to the server device, and
the server device comprising:
a quiz result data receiver for receiving quiz result data from each of the plural game terminals;
a calculation mandatory data storage device that stores, for each quiz question, data of parameters mandatory for accuracy rate calculation as calculation mandatory data;
a calculation mandatory data updater that updates, based on the quiz result data received by the quiz result data receiver, the calculation mandatory data for a quiz question having an identifier indicated by the quiz result data;
an accuracy rate calculator that calculates, with the calculation mandatory data updated by the calculation mandatory data updater, the accuracy rate of a quiz question corresponding to the calculation mandatory data;
an accuracy rate adequacy determiner that determines whether the accuracy rate calculated by the accuracy rate calculator is outside a predetermined adequate range; and
a question blocking data transmitter that transmits, to each of the plural game terminals, the question blocking data in which a quiz question having the accuracy rate that is determined by the accuracy rate adequacy determiner to be outside the adequate range is set as the particular quiz question.

2. A game system according to claim 1,
wherein the server device further comprises a difficulty degree data storage device that stores, for each quiz question, difficulty degree data showing the degree of difficulty for each quiz question;
wherein the adequate range is determined in advance depending on the degree of difficulty for a quiz question; and
wherein the accuracy rate adequacy determiner determines whether the accuracy rate calculated by the accuracy rate calculator is outside the adequate range determined in advance depending on the degree of difficulty of the quiz question for which the accuracy rate was calculated by the accuracy rate calculator.

3. A game system according to claim 1,
wherein the question blocking data indicates an identifier of the particular quiz question; and
wherein the quiz question decider decides, as a quiz question to be asked in the quiz, a quiz question having an identifier that is not indicated by the question blocking data received by the question blocking data receiver.

4. A server device for providing a service to each of plural game terminals, the server device comprising:
a quiz result data receiver for receiving quiz result data from each of the plural game terminals that receives question blocking data for blocking a particular quiz question from being asked in a quiz, that decides a quiz question to be asked in the quiz, that asks a player the decided quiz question in the quiz, that receives an answer to the quiz question in the quiz, and that generates quiz result data showing an identifier of the quiz question and a result of the quiz for transmission;
a calculation mandatory data storage device that stores, for each quiz question, data of parameters mandatory for accuracy rate calculation as calculation mandatory data;
a calculation mandatory data updater that, based on quiz result data received by the quiz result data receiver, updates the calculation mandatory data for a quiz question having an identifier indicated by the quiz result data;
an accuracy rate calculator that uses the calculation mandatory data updated by the calculation mandatory data updater and that calculates the accuracy rate of a quiz question corresponding to the calculation mandatory data;
an accuracy rate adequacy determiner that determines whether the accuracy rate calculated by the accuracy rate calculator is outside a predetermined adequate range; and
a question blocking data transmitter that transmits, to each of the plural game terminals, the question blocking data in which a quiz question having the accuracy rate that is determined by the accuracy rate adequacy determiner to be outside the adequate range is set as the particular quiz question.

5. A computer program for running on a computer that provides a service to each of plural game terminals, the computer program, when run on the computer, at least including computer readable instructions for performing the steps of:
receiving quiz result data from each of the plural game terminals that receives question blocking data for blocking a particular quiz question from being asked in a quiz, that decides a quiz question to be asked in the quiz, that asks a player the decided quiz question in the quiz, that receives an answer to the quiz question in the quiz, that generates quiz result data indicating an identifier of the quiz question and a result of the quiz for transmission;
updating, based on quiz result data received in the receiving step, calculation mandatory data for a quiz question having an identifier designated by the quiz result data, the calculation mandatory data being stored in a calculation mandatory data storage device that stores, for each quiz question, data of parameters mandatory for accuracy rate calculation as calculation mandatory data;
calculating, by using the calculation mandatory data updated in the updating step, the accuracy rate of a quiz question corresponding to the calculation mandatory data;
determining whether the accuracy rate calculated in the calculating step is outside a predetermined adequate range; and
transmitting, to each of the plural game terminals, the question blocking data in which a quiz question having the accuracy rate that is determined in the determining step to be outside the adequate range is set as the particular quiz question.

6. A computer-readable recording medium having stored therein a computer program for running on a computer that provides a service to each of plural game terminals, the computer program, when run on the computer, at least including computer readable instructions for performing the steps of:
receiving quiz result data from each of the plural game terminals that receives question blocking data for blocking a particular quiz question from being asked in a quiz, that decides a quiz question to be asked in the quiz, that asks a player the decided quiz question in the quiz, that receives an answer to the quiz question in the quiz, that generates quiz result data indicating an identifier of the quiz question and a result of the quiz for transmission;
updating, based on quiz result data received in the receiving step, calculation mandatory data for a quiz question having an identifier designated by the quiz result data, the calculation mandatory data being stored in a calculation mandatory data storage device that stores, for each quiz question, data of parameters mandatory for accuracy rate calculation as calculation mandatory data;
calculating, by using the calculation mandatory data updated in the updating step, the accuracy rate of a quiz question corresponding to the calculation mandatory data;
determining whether the accuracy rate calculated in the calculating step is outside a predetermined adequate range; and
transmitting, to each of the plural game terminals, the question blocking data in which a quiz question having the accuracy rate that is determined in the determining step to be outside the adequate range is set as the particular quiz question.
